(19) United States
(12) Patent Application Publication
(10) Pub. No.: US 2018/0200744 A1
(43) Pub. Date: Jul. 19, 2018

(54) PUMP MECHANISM FOR A SPRAY DISPENSER

(71) Applicant: Alternative Packaging Solutions, LLC, New York, NY (US)

(72) Inventor: Christopher John AWORTH, Northhamptonshire (GB)

(21) Appl. No.: 15/743,358

(22) PCT Filed: Jul. 16, 2016
(86) PCT No.: PCT/US2016/042683

§ 371 Date: Jan. 10, 2018

(30) Foreign Application Priority Data
Jul. 17, 2015 (GB) 1512638.6

(51) Int. Cl. B05B 9/08; B05B 11/00

(52) U.S. Cl. CPC B05B 9/0883; B05B 11/3076; B05B 11/3011; B05B 11/3091

(57) ABSTRACT

A pump mechanism for a spray dispenser, comprising a piston assembly movable with respect to a housing between charged and initial positions. The piston assembly comprises liquid and gas seals, being movable boundaries of respective chambers whose volume is determined by the position of the seal relative to the housing. When the piston assembly moves toward the charged position, the volume of the liquid chamber increases to draw liquid into the liquid chamber and the changing volume of the gas chamber changes the pressure of gas in that chamber from its pressure when the piston assembly was in the initial position. This biases the piston assembly to return from the charged position toward the initial position, that return movement of the piston assembly pressurising the liquid in the liquid chamber for dispensing.

This invention relates to spray dispensers, in particular to hand-operated pump mechanisms for spray dispensers that pressurise liquid for dispensing by non-chemical means.

Spray dispensers provide a convenient, portable system for dispensing liquid in droplets as a spray. Such dispensers are used widely in many commercial fields, including cosmetics and personal hygiene, household products, pharmaceuticals, and in industry, for example in the application of lubricants, paints and varnishes.

A spray is typically produced by forcing liquid under pressure through a small opening. The pressure required is typically provided by a partially-vaporised liquefied propellant gas that is mixed with the liquid to be dispensed within a sealed container such that upon actuation the liquid is expelled from the container as a mixture with the vaporised propellant gas.

Volatile hydrocarbons such as propane, n-butane and isobutene are often used as the propellant gas. Nitrous oxide and carbon dioxide are also used as propellants to deliver foodstuffs (for example, whipped cream and cooking spray). Medicinal aerosols such as asthma inhalers typically use hydrofluoroalkanes (HFAs).

The use of liquefied propellant gas in spray dispensers is well known but suffers from significant disadvantages. Firstly, the most widely used propellant gases are highly flammable. This presents a fire risk in use, and during manufacture and disposal of the dispensers.

The hazards associated with common liquefied propellant gases complicate the production of pressurised containers. This adds to the time and costs associated with production.

Furthermore, pressurised containers cannot be readily re-filled when empty and are therefore inherently one-use only before they need to be disposed. This introduces environmental concerns.

Manual pump spray mechanisms are an alternative means for providing a spray dispenser. In their simplest form, ‘pump-action’ or ‘trigger’ sprays expel fluid in short bursts in direct response to a pressurising action of the user, for example by depressing a plunger or squeezing a trigger. It is inconvenient when such pressurising actions must be performed concurrently with spray dispensing, which can make such mechanisms awkward to use.

More complex manual pump mechanisms are known that have a means temporarily to store the pressure generated. This allows a prolonged spray that does not depend upon concurrent pressurising actions. Examples of this type of mechanism involve reciprocal plunger operation, or multiple trigger actions to generate a pre-dispensing pressure. However, these systems still require multiple actions and prolonged activity of the user in order to charge the system prior to dispensing. This is unappealing to users who are accustomed to the ready-to-use convenience of existing pre-pressurised spray dispensers.

WO 2013/154554, WO 2013/154555 and WO 2013/151548 each describe various embodiments of a prolonged spray dispenser that requires a simple one-turn charging step to pressurise the fluid to be dispensed prior to dispensing. The energy storage means in these dispensers is mechanical in the form of a metal helical spring.

Springs of metal are cheap to produce, provide a consistent force under compression, and are reliable. However, such springs can suffer from the disadvantage that if they are not perfectly sealed within the pump mechanism they may come into contact with the liquid to be dispensed. In some cases, this can lead to corrosion of the metal in the spring causing possible discolouration of the liquid to be dispensed and weakening and the potential failure of the spring. It may add to the cost and complexity of the dispenser to maintain an adequate seal between the liquid to be dispensed and the spring.

It may also be commercially attractive to offer an alternative energy storage means in a pump mechanism for a spray dispenser.

It is against this background that the present invention has been devised.

The invention resides in a first aspect in a pump mechanism for a spray dispenser, comprising:
a housing;
a piston assembly movable with respect to the housing between a charged position and an initial position, the piston assembly comprising a liquid seal and a gas seal, each in slidable sealed relation with the housing;
a sealed gas chamber of which the gas seal is a movable boundary, such that the volume of the gas chamber is determined by the position of the gas seal relative to the housing; and
a liquid chamber of which the liquid seal is a movable boundary, such that the volume of the liquid chamber is determined by the position of the liquid seal relative to the housing, the liquid chamber comprising an inlet to admit liquid into the liquid chamber, and an outlet to expel the admitted liquid from the liquid chamber for dispensing;
   wherein, when the piston assembly moves from the initial position to the charged position,
the volume of the liquid chamber is increased by movement of the liquid seal to draw liquid into the liquid chamber via the inlet;
the volume of the gas chamber is changed by movement of the gas seal to change the pressure of gas in the gas chamber from the pressure of that gas when the piston assembly was in the initial position; and
the changed internal pressure in the gas chamber biases the piston assembly to return subsequently from the charged position toward the initial position, that return movement of the piston assembly moving the liquid seal relative to the housing to pressurise the liquid drawn into the liquid chamber for dispensing via the outlet.

In an embodiment of the present invention, when the piston assembly moves from the initial position to the charged position, the volume of the sealed gas chamber is decreased and the internal pressure of the gas is increased, and vice versa.

In an alternative embodiment of the present invention, when the piston assembly moves from the initial position to the charged position, the volume of the sealed gas chamber is increased and the internal pressure of the gas is decreased, and vice versa.

In an embodiment of the present invention, the housing of the pump mechanism of the invention comprises a generally tubular body closed by a base wall. Suitably, the base wall comprises the inlet to the liquid chamber.

In an embodiment, the pump mechanism of the present invention a non-return valve is provided in a duct leading to the inlet.

In another embodiment of the invention, the pump mechanism further comprises a power screw engaged with the piston assembly whereby rotation of the power screw moves the piston assembly axially along the power screw between the initial position and the charged position. Suitably, the pump mechanism further comprises a dispense head that is movable between an extended rest position in which the power screw is engaged with the dispense head to prevent rotation of the power screw relative to the dispense head, and a depressed actuating position in which the power screw is disengaged from the dispense head to permit rotation of the power screw relative to the dispense head.

The power screw typically comprises a radially-extending head piece having one or more engagement formations for engagement with one or more complementary engagement formations of the dispense head when the dispense head is in the rest position. Suitably, the head piece is a disc having a radially outer edge that comprises external radially-extending teeth engageable with one or more inwardly-facing lugs of the dispense head when the dispense head is in the rest position.

In an embodiment of the invention, the power screw comprises an elongate shaft. Suitably, the shaft extends through the piston assembly. Typically, the shaft is hollow with a closed end and an open end.

In certain embodiments, at or near its closed end, the shaft comprises the outlet of the liquid chamber. Suitably, the outlet is an aperture in the shaft for fluid communication between the liquid chamber and the hollow interior of the shaft. Optionally, the aperture is closed by the liquid seal when the piston assembly moves toward the initial position.

In an embodiment of the invention, the pump mechanism further comprises an actuation valve that is operable to seal the open end of the shaft is response to release of a dispense head from a depressed actuating position. Suitably, the actuation valve is positioned within the open end of the shaft to seal the hollow shaft of the power screw, the actuation valve comprising a valve seat and an actuation stem that extends through the valve seat and is movable relative to the valve seat by movement of the dispense head.

In a further embodiment of the invention, the power screw comprises a retainer formation that engages with the housing or with a retainer part supported by the housing to retain the power screw in a longitudinally-fixed position relative to the housing

In an embodiment of the invention, the liquid chamber and the gas chamber are contained within the housing. Suitably, the liquid chamber is longitudinally displaced from the gas chamber. Typically, the gas chamber extends radially outboard of the liquid chamber. Alternatively, the gas chamber is concentrically arranged around the liquid chamber. In an embodiment, the liquid chamber extends radially outboard of a radially inner wall of the gas chamber.

In an embodiment of the invention, the piston assembly is in the initial position, the gas pressure within the gas chamber is above or below ambient pressure.

In a further embodiment of the invention, the liquid seal and the gas seal are formed as a single seal formation.

In an embodiment, rotation of the piston assembly is prevented by anti-rotation features between the housing and the piston assembly. Suitably, the anti-rotation features are slots or grooves or splines.

In an embodiment of the invention, the pump mechanism is configured to provide a duration of spray. In embodiments, the spray duration is at least 1 second, preferably at least 5 or 10 seconds, most preferably the spray duration is at least 20 seconds. Typically, the spray duration is at most 60 seconds, preferably a most 50 seconds, most preferably at most 30 seconds. In embodiments, the pump mechanism is configured to provide a duration of spray in the range of 1 to 50 seconds, preferably in the range of 1 to 20 seconds, alternatively in the range of 5 to 20 seconds, most preferably in the range of 10 and 20 seconds.

In a further embodiment of the invention, the gas sealed in the gas chamber is air.

In an alternative embodiment, the housing further comprises an annular collar for connecting the mechanism to a container.

In a second aspect, the invention relates to a spray dispenser comprising the pump mechanism of the first aspect of the invention and a container. Suitably, the pump mechanism is mounted on the container so that the pump mechanism lies concentrically within the container. Typically, the dispense head only protrudes from the container.

In order that the invention may be more readily understood, reference will now be made, by way of example, to the accompanying drawings in which:

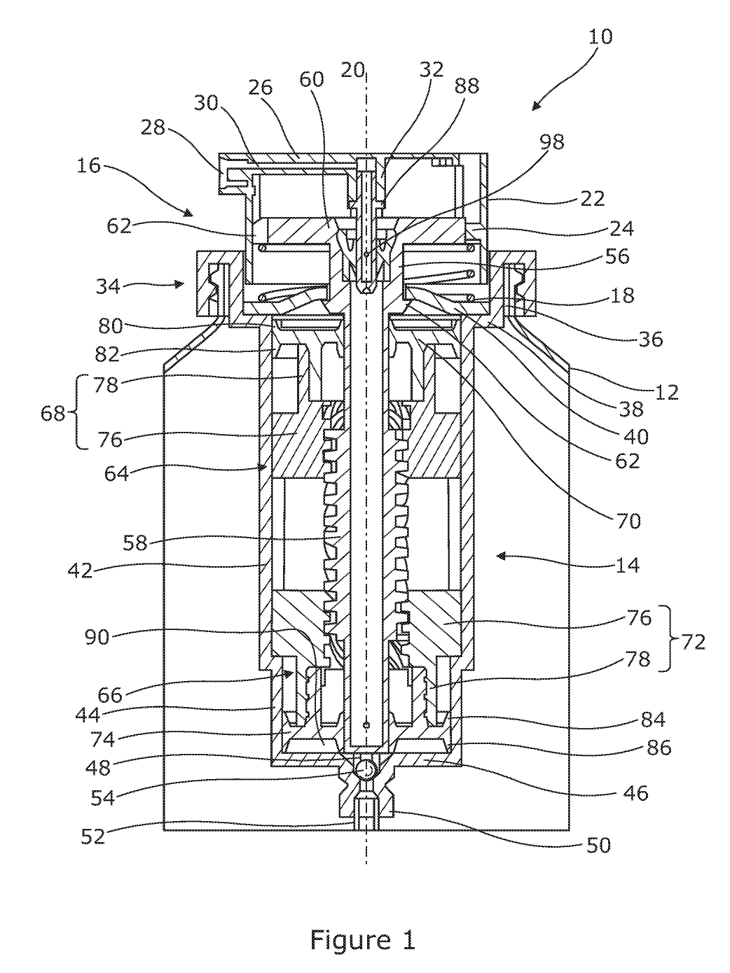

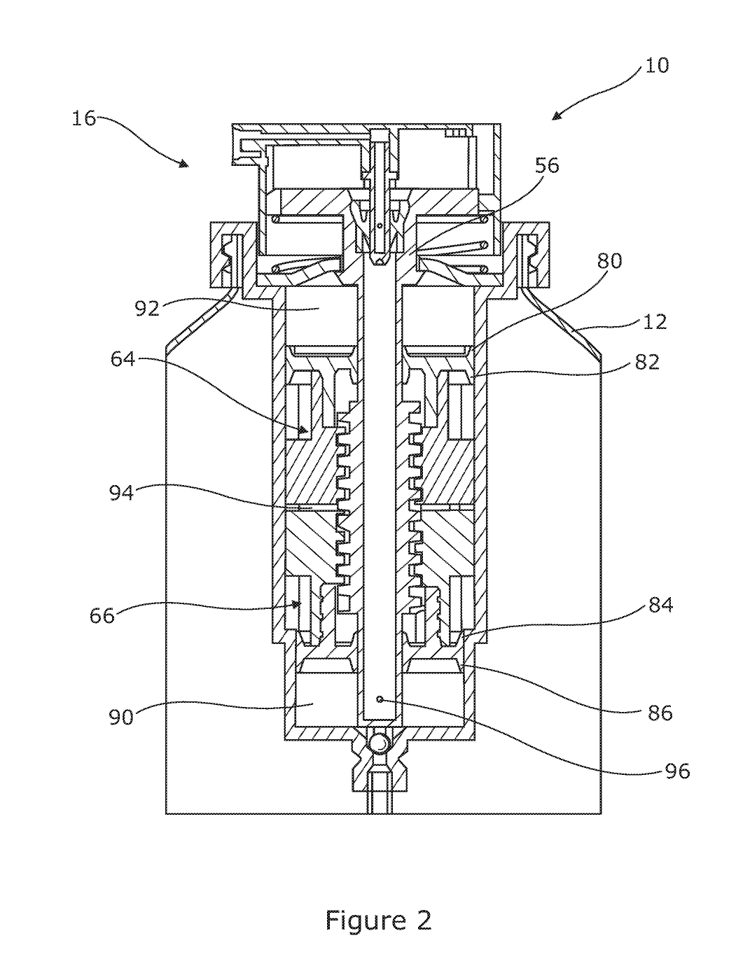

FIGS. 1 and 2 are longitudinal section views of a gas spring pump in accordance with the present invention. FIG. 1 shows the pump in a zero-charge or resting state; FIG. 2 shows the pump in a charged state.

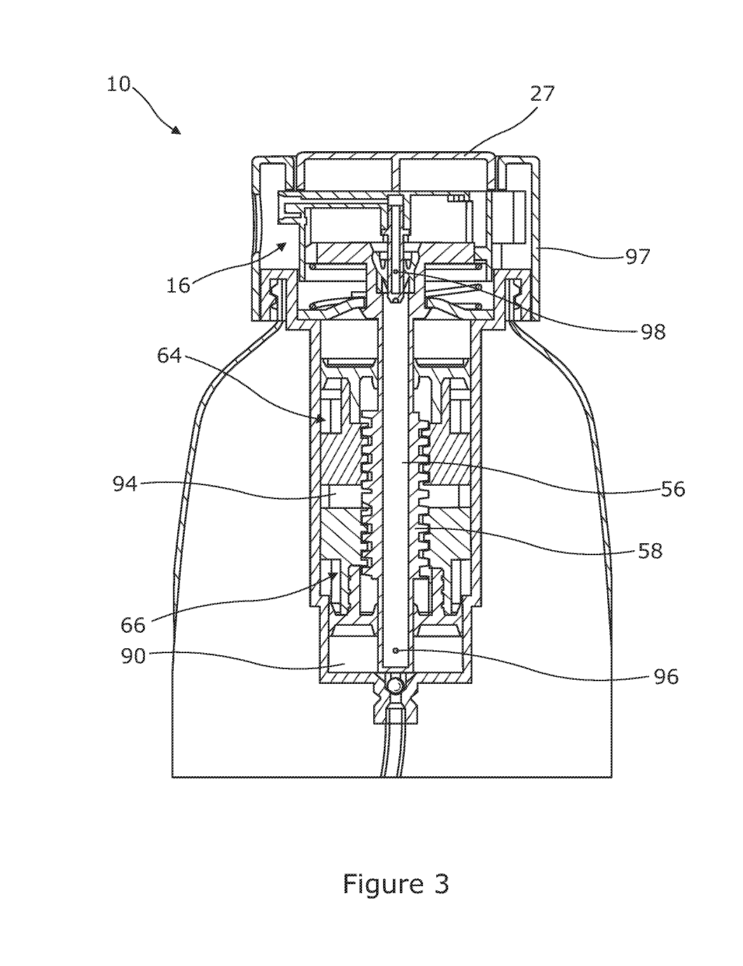

FIG. 3 is a longitudinal section view of the embodiment of a gas spring pump as shown in FIGS. 1 and 2, with an optional actuation sleeve and actuation button.

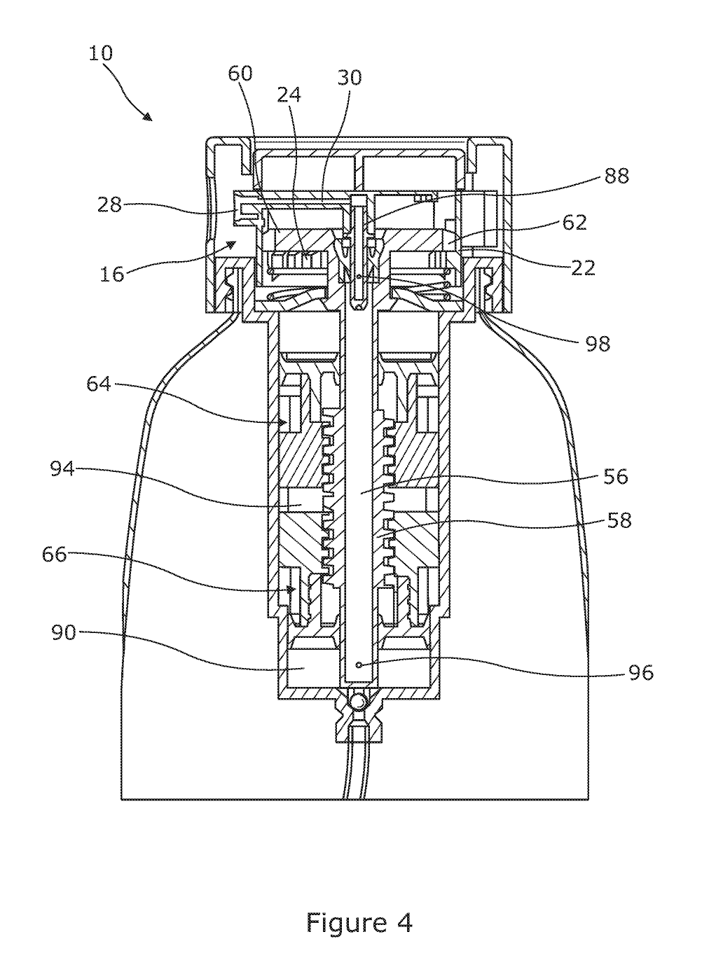

FIGS. 4 to 6 are longitudinal section views that show the dispensing action of the embodiment of a gas spring pump shown in FIG. 3.

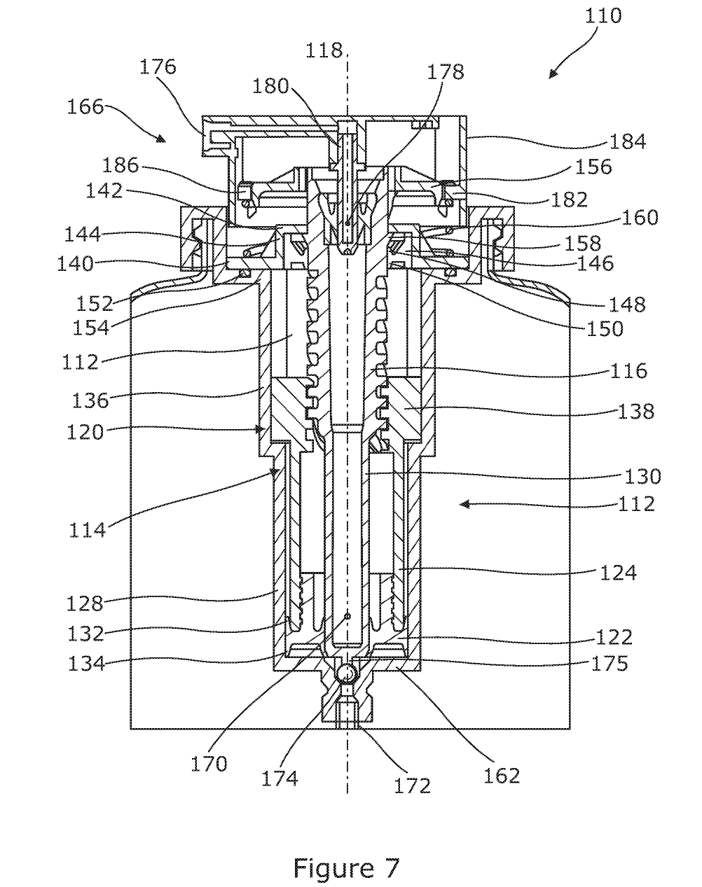

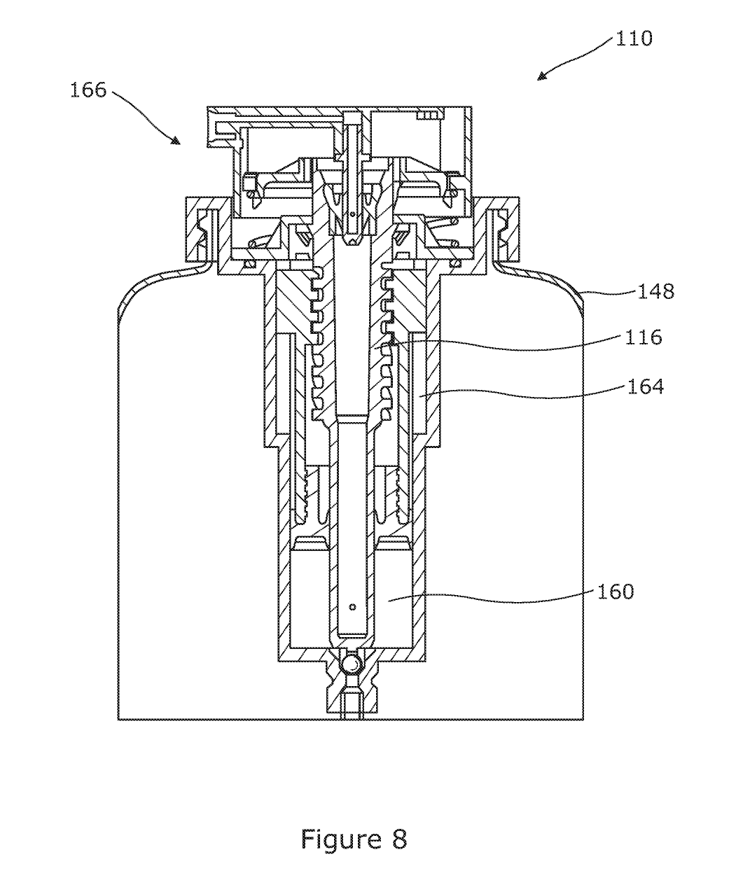

FIGS. 7 and 8 are longitudinal section views of a further embodiment of a gas spring pump in accordance with the present invention. FIG. 7 shows the pump in a zero-charge or resting state; FIG. 8 shows the pump in a charged state.

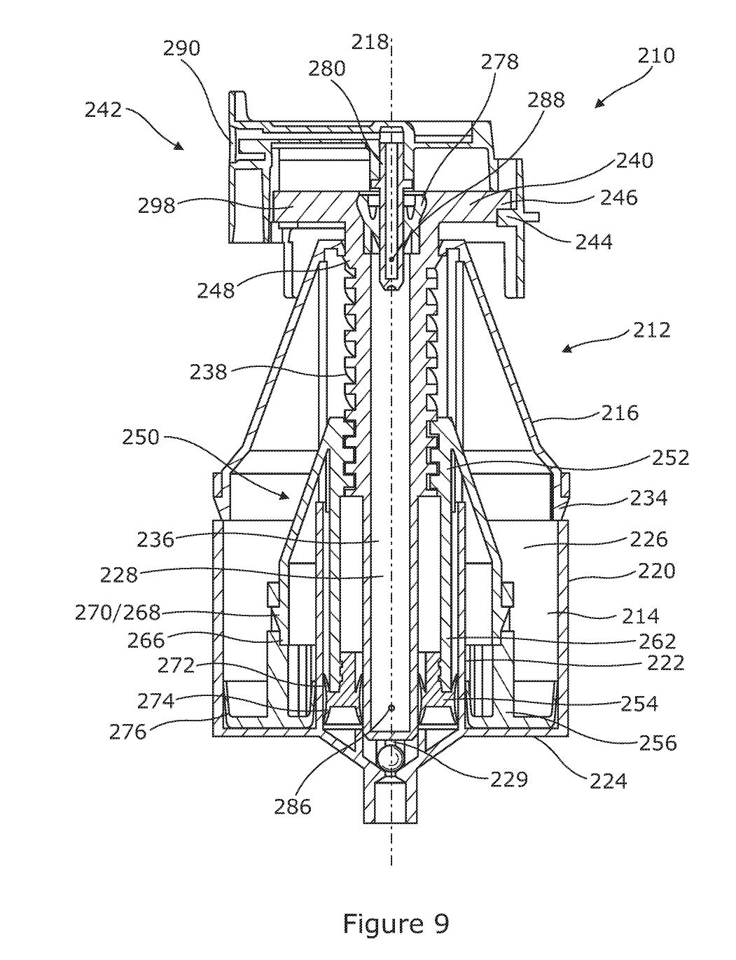

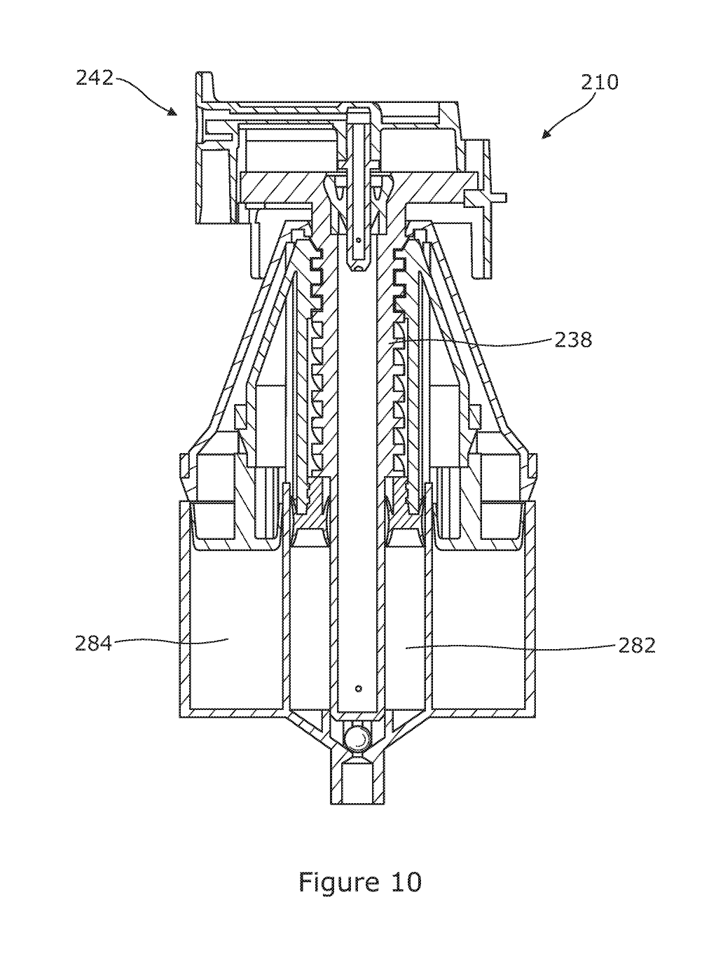

FIGS. 9 and 10 are longitudinal section views of a further embodiment of a gas spring pump in accordance with the present invention. FIG. 9 shows the pump in a zero-charge or resting state; FIG. 10 shows the pump in a charged state.

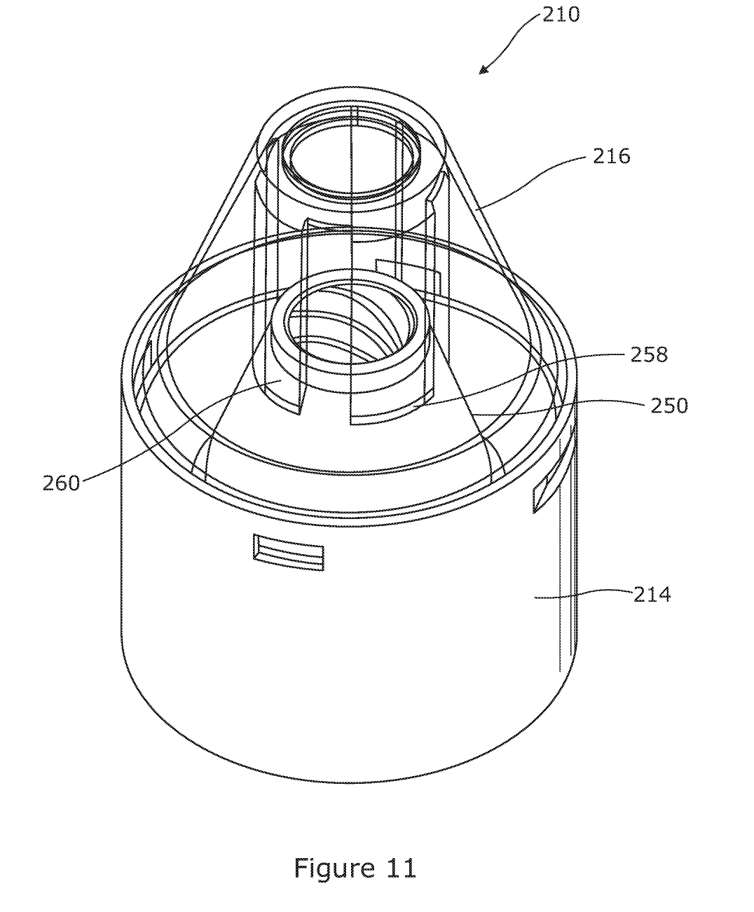

FIG. 11 shows the embodiment of the gas spring pump of FIGS. 9 and 10 in perspective view. Some outer components have been shown as semi-transparent so that interior components can be seen. The dispense head and power screw have been omitted for clarity.

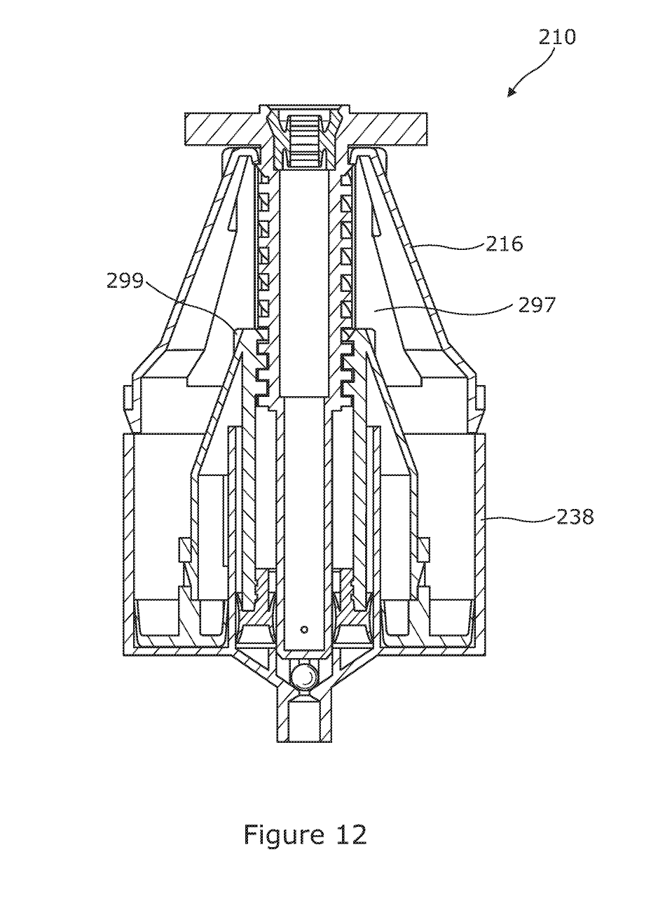

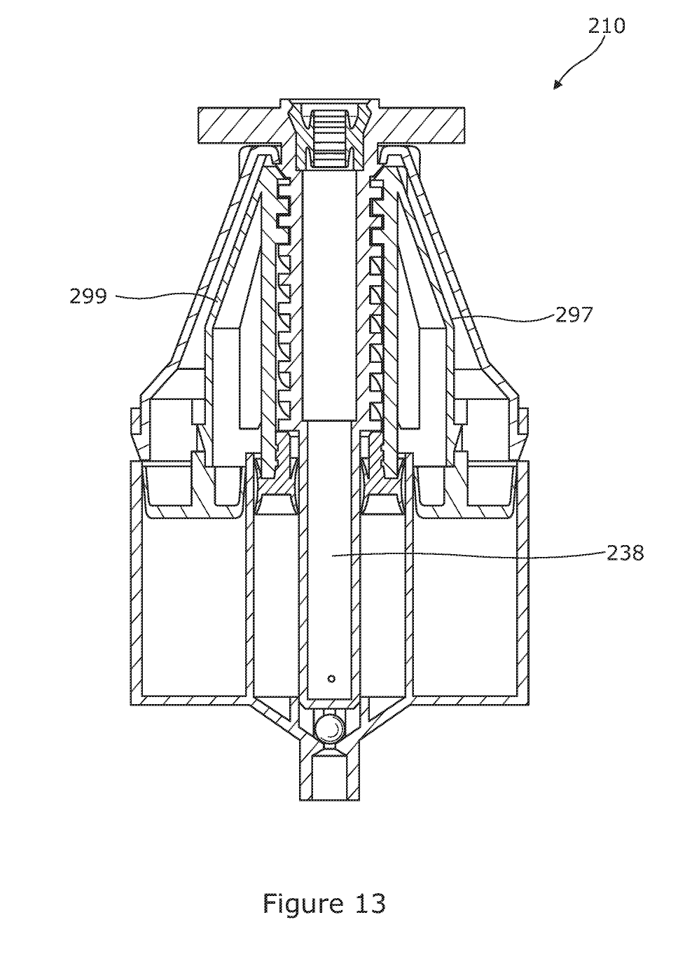

FIGS. 12 and 13 are a longitudinal section view of a further embodiment of a gas spring pump in accordance with the present invention. FIG. 12 shows the pump in a zero-charge or resting state; FIG. 13 shows the pump in a charged state.

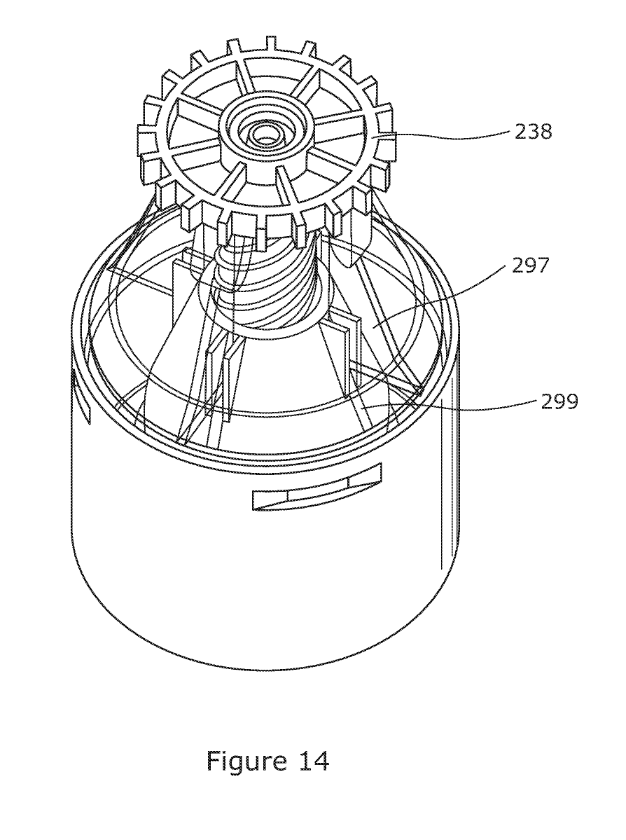

FIG. 14 shows the embodiment of the gas spring pump of FIGS. 12 and 13 in perspective view. Some outer components have been shown as semi-transparent so that interior components can be seen. The dispense head has been omitted for clarity.

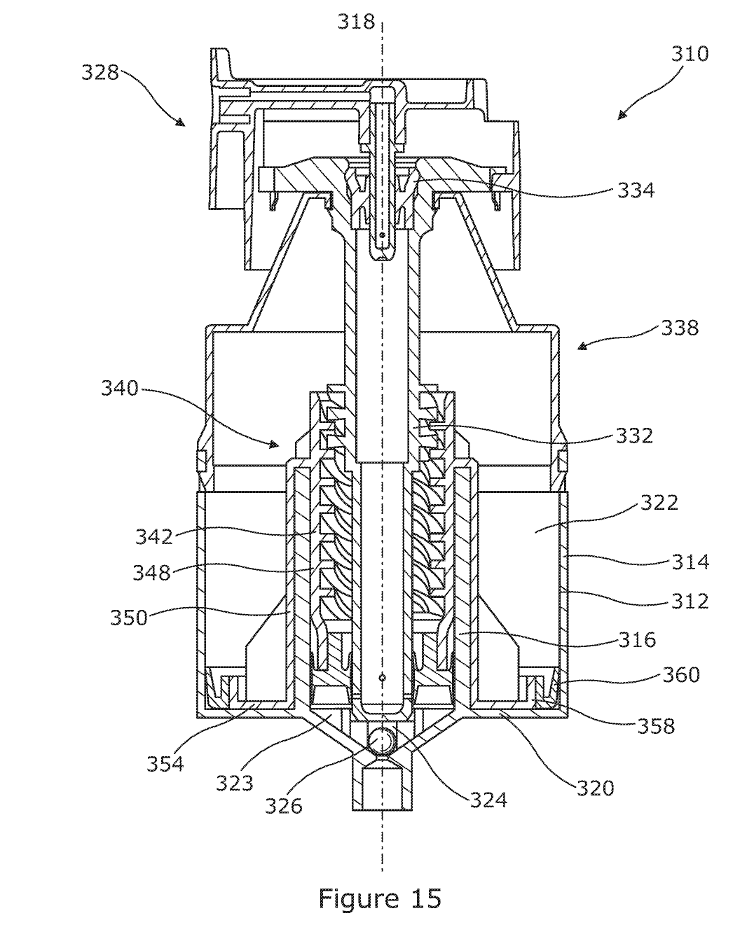

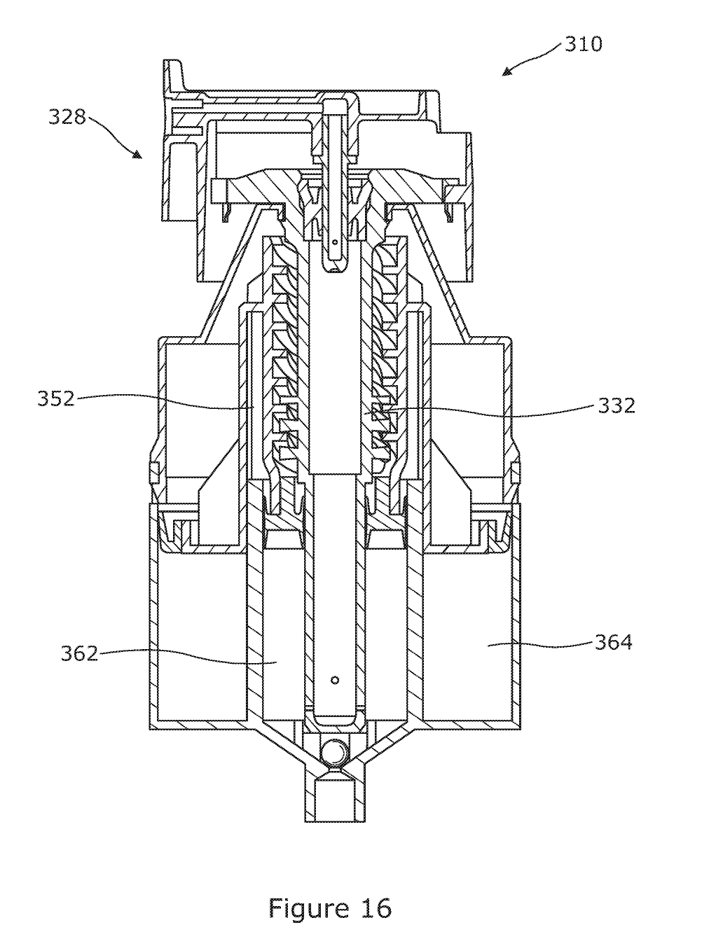

FIGS. 15 and 16 are a longitudinal section view of a further embodiment of a gas spring pump in accordance with the present invention. FIG. 15 shows the pump in a zero-charge or resting state; FIG. 16 shows the pump in a charged state.

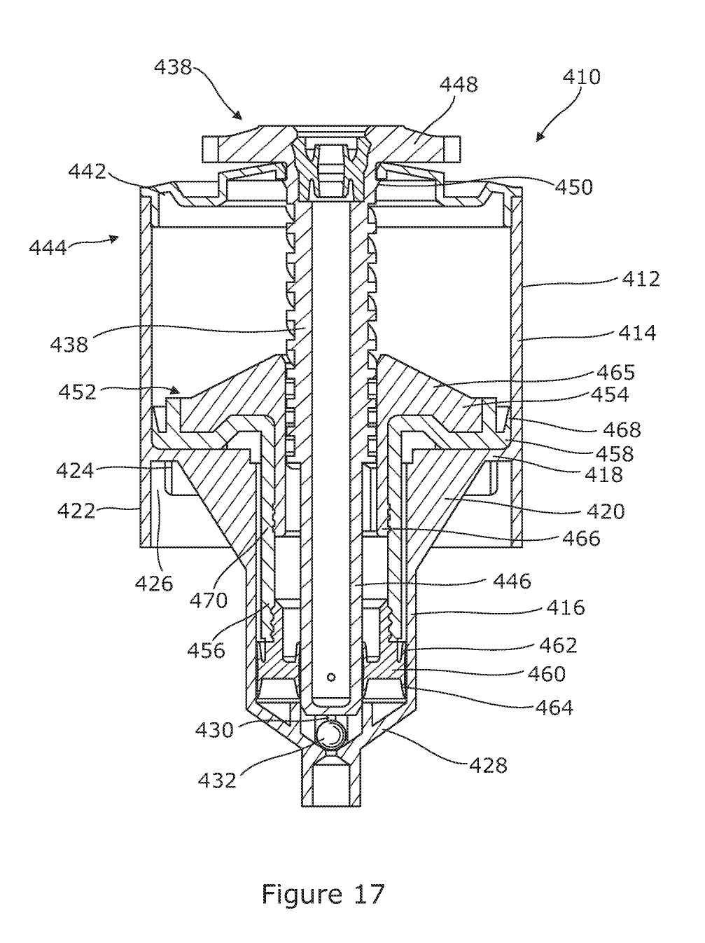

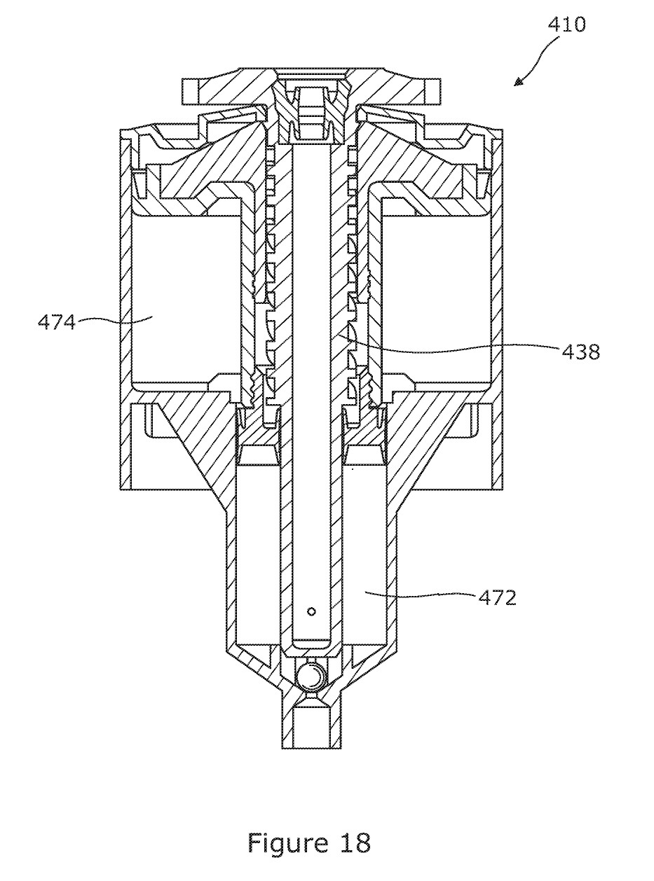

FIGS. 17 and 18 are a longitudinal section view of a further embodiment of a gas spring pump in accordance with the present invention. FIG. 17 shows the pump in a zero-charge or resting state; FIG. 18 shows the pump in a charged state.

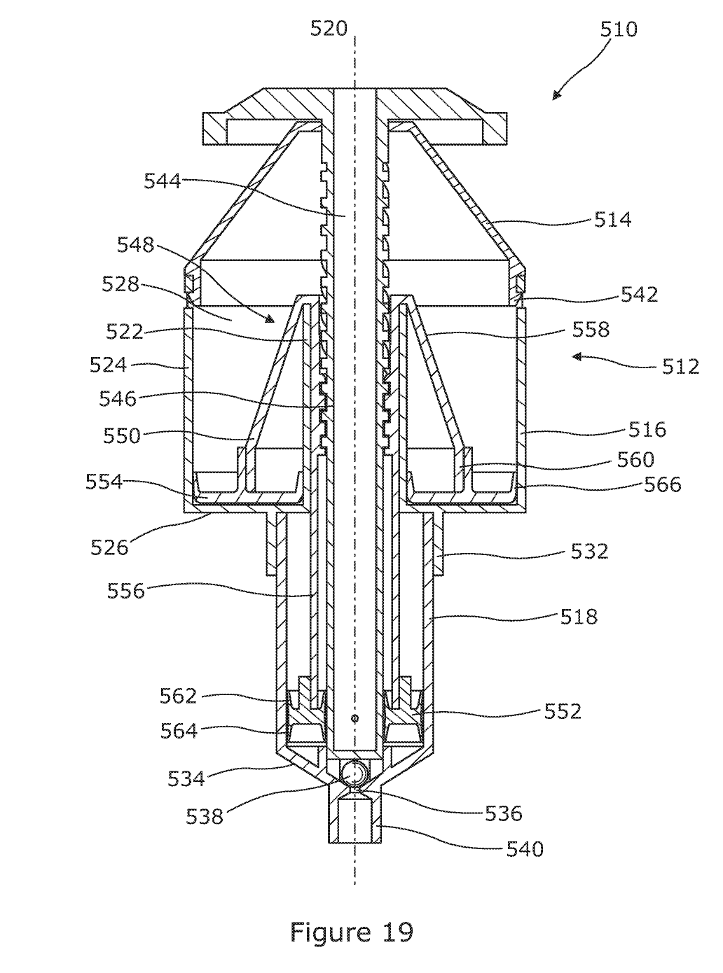

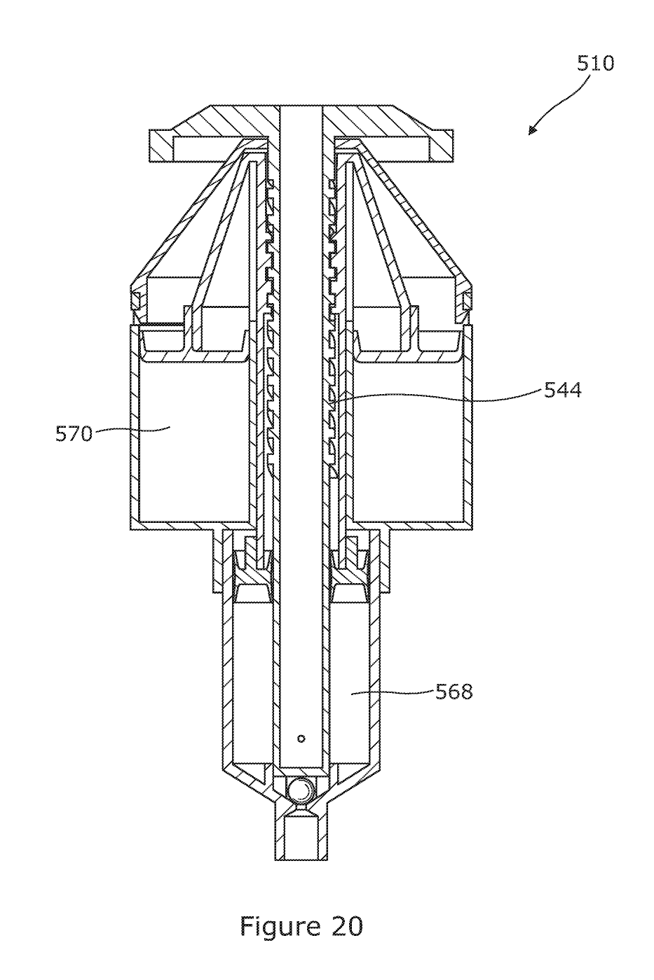

FIGS. 19 and 20 are longitudinal section views of a further embodiment of a gas spring pump in accordance with the present invention. FIG. 19 shows the pump in a zero-charge or resting state; FIG. 20 shows the pump in a charged state.

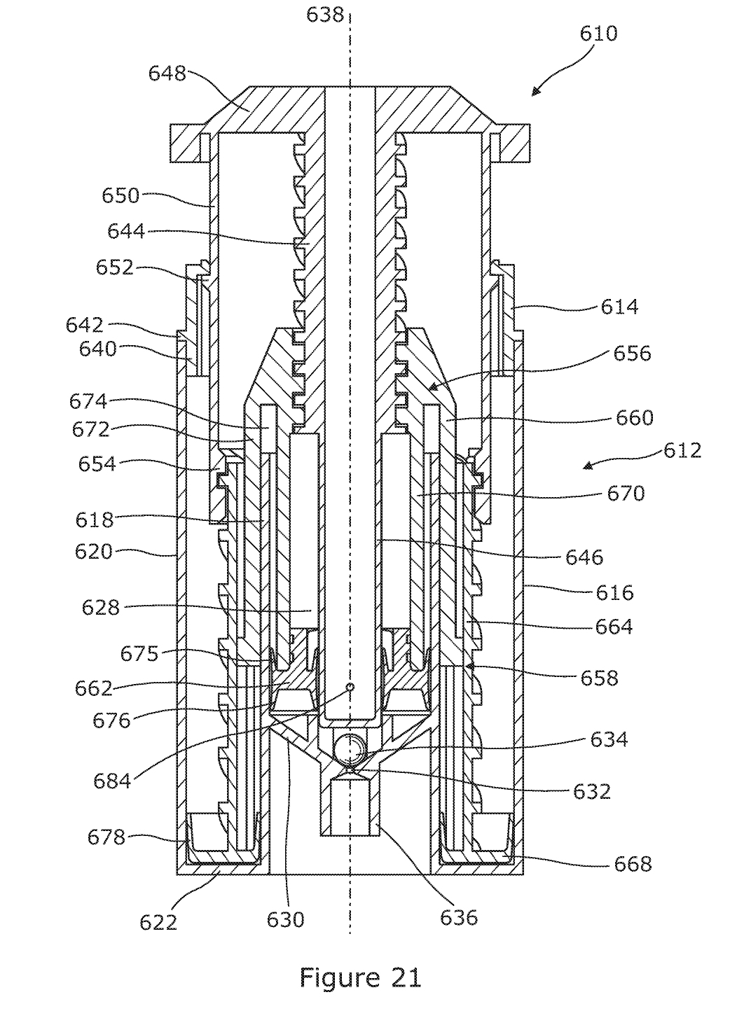

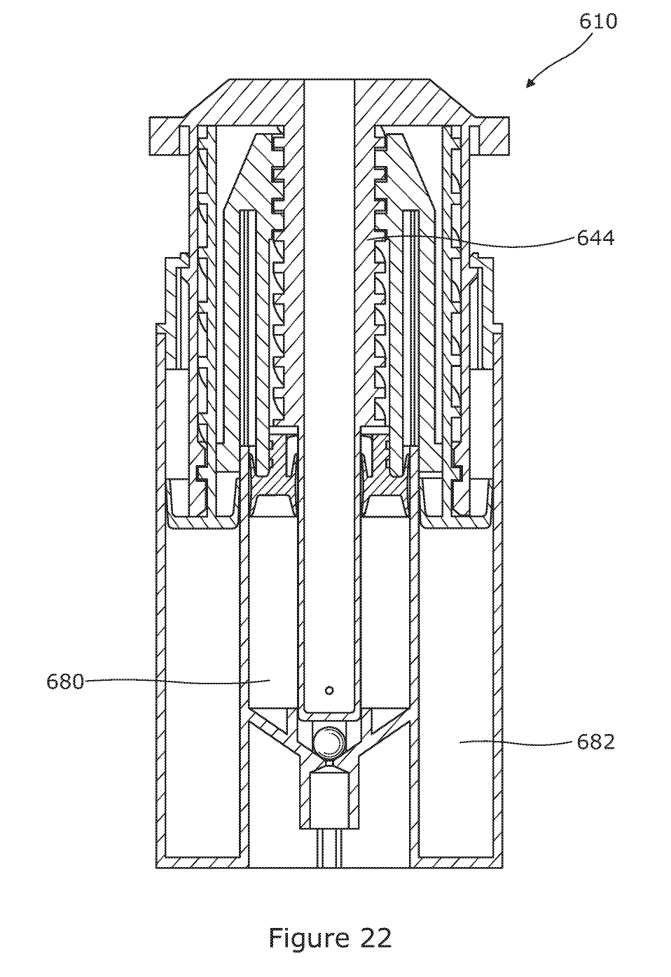

FIGS. 21 and 22 are longitudinal section views of a further embodiment of a gas spring pump in accordance with the present invention. FIG. 21 shows the pump in a zero-charge or resting state; FIG. 22 shows the pump in a charged state.

Positive Pressure Gas Spring Pumps

FIGS. 1 and 2 of the drawings show a gas spring pump 10 according to an embodiment of the invention, fitted to a container 12.

The gas spring pump 10 comprises a generally tubular housing 14, a hollow dispense head 16 and a helical spring 18 within the dispense head 16. The housing 14 and the container 12 are each rotationally symmetrical about a common central longitudinal axis 20 that lies in a generally vertical orientation when the container 12 is oriented for use. The housing 14 lies concentrically within the container 12.

The dispense head 16 is positioned at the outer or upper end of the housing 14 to protrude from the container 12. The dispense head 16 is biased outwardly into an upwardly-extended position by the helical spring 18, which lies within a downwardly-extending, open-bottomed tubular skirt 22 of the dispense head 16. One or more integrally-moulded lugs 24 protrude radially inwardly from the skirt 22.

The upper or outer end of the dispense head 16 is closed by a top wall 26 that may serve as an actuation button.

A nozzle 28 protrudes radially from one side of the skirt and is supplied with a liquid product to be dispensed via a nozzle path 30 that extends radially under the top wall 26 and through a downwardly-extending tubular boss 32 on the central longitudinal axis 20.

At its outer or upper end, the main tubular body of the housing 14 is surmounted by an annular collar 34 that has an n-section whose shape defines a downwardly-facing annular groove 36 between inner and outer concentric walls. The groove 36 is configured to receive the neck of the container 12. The groove 36 and the neck of the container 12 have complementary engagement formations that reversibly or irreversibly retain the gas spring pump 10 in the neck of the container 12. The engagement formations may, for example, provide for snap-fit or threaded engagement between the gas spring pump 10 and the neck of the container 12. They also seal the gas spring pump 10 to the neck of the container 12.

In the embodiment shown in FIG. 1, the inner wall of the collar 34 is radially outside, and axially displaced outwardly or upwardly from the outer end of, the main tubular body of the housing 14. A radially-extending shoulder 38 joins the inner wall of the collar 34 to the outer or upper end of the main tubular body. The inner wall and the shoulder form a well that receives and supports the dispense head 16 for reciprocal sliding movement within the collar 34 along the central longitudinal axis 20. At the base of the well, an annular retainer disc 40 seats onto the outer side of the shoulder 38 and lies between the shoulder 38 and the spring 18.

The main tubular body of the housing 14 comprises a major tubular portion 42 at its outer or upper end and a minor tubular portion 44 at its inner or lower end. The major tubular portion 42 has a diameter greater than that of the minor tubular portion 44. A radially-extending circumferential step joins the major tubular portion 42 and the minor tubular portion 44 to confer a stepped profile on the main tubular body in longitudinal section. The step is directed radially inwardly moving in a downward or inward direction from the major tubular portion 42 to the minor tubular portion 44.

The inner or lower end of the housing 14 is closed by a base wall 46. The base wall 46 has an opening 48 on the central longitudinal axis 20 through which liquid to be dispensed may pass.

On the external side of the base wall 46, a tubular attachment formation 50 surrounds the opening 48 for receiving an upper end of a dip tube 52. The dip tube 52 extends downwardly from the tubular attachment formation 50 into a body of liquid to be dispensed. That body of liquid is held in the container 12 below when in use but is not shown in the drawings. The opening contains a one-way valve 54 to allow the liquid to flow in one direction only, from the container 12 into the housing 14, and not to return from the housing 14 to the container 12.

A central power screw 56 comprises a hollow elongate tubular shaft 58 that is centred on the central longitudinal axis 20 and turns about that axis within the housing 14. At its closed inner or lower end, the shaft 58 extends to, and bears against, the base wall 46 of the housing 14. An integral head 60 surrounding the outer or upper open end of the shaft 58 lies outside the housing 14 but within the dispense head 16.

The head of the power screw 60 is a generally circular disc extending radially from the shaft 58 such that the power screw 56 is generally T-shaped in longitudinal section. A radially outer edge of the head is externally toothed in plan view to engage with the, or each, lug 24 that protrudes radially inwardly from the skirt 22 of the dispense head 16. Such engagement occurs when the dispense head 16 is in an outward or upper rest position.

When the dispense head 16 is depressed to dispense liquid product through the nozzle 28, the, or each, lug 24 disengages from the teeth 62 surrounding the head 60 of the power screw 56. This frees the power screw 56 for rotation relative to the dispense head 16. Also, the, or each, lug 24 then bears against the helical spring 18, which biases the dispense head 16 to return to the rest position when released and hence to re-engage the head 60 of the power screw 56.

At the junction between the shaft 58 and the head 60 of the power screw 56, the shaft 58 is radially enlarged to define a radially-extending flange 62. The flange 62 engages a central hole of the retainer disc 40 to retain the power screw 56 with respect to the housing 14. The flange 62 has a downwardly-tapered frusto-conical edge to pass through the central hole and then to snap-fit under the retainer disc 40 around the edge of the hole. This eases incorporation of the power screw 56 into the assembly during manufacture. The helical spring 18 bears against the underside of the head 60 of the power screw 56 to bias the flange 62 against the retainer disc 40.

The main tubular body of the housing 14 surrounds and supports two annular piston assemblies 64, 66. The body of the housing 14 is internally splined with one or more longitudinally-extending ribs that engage with one or more complementary grooves on the outer side of each piston assembly 64, 66. This prevents the piston assemblies 64, 66 turning within the housing 14 and so constrains the piston assemblies 64, 66 to move only longitudinally with respect to the housing 14. The piston assemblies 64, 66 surround the power screw 56 and are each separately engaged with the power screw 56. For this purpose, the power screw 56 has a male thread and the piston assemblies have complementary female threads.

The helical threads of the power screw 56 and the piston assemblies 64, 66 are arranged such that on rotation of the power screw 56 around the central longitudinal axis 20, the piston assemblies 64, 66 move axially along the power screw 56 in opposite directions. To achieve this, the piston assemblies 64, 66 have mutually-opposed helical threads that mate with complementary mutually-opposed axially-adjoining thread portions on the power screw 56.

A first, or upper, piston assembly 64 comprises an annular first piston body 68 and an annular first piston seal 70. A second, or lower, piston assembly 66 comprises an annular second piston body 72 and an annular second piston seal 74. The piston bodies 68, 72 are formed of rigid plastics whereas the piston seals 70, 74 are formed of resilient plastics, an elastomeric material or a rubber.

Each piston body 68, 72 is shaped to define a head portion 76 and a tubular skirt 78. The head portion 76, 77 fills the diameter of the major portion of the housing 42, hence sliding against the interior of the housing 14 for support. The tubular skirt 78 extends from the base of the head portion 76 radially inboard from the periphery of the head portion 76 to give the piston body 68, 72 a general T-shape in longitudinal cross-section. The skirt 78 supports and stiffens the piston seal 70, 74 and into which root portion of the piston seal 70, 74 fits.

The piston seals 70, 74 have lip seal formations that extend axially in the direction of relative movement between the piston seals 70, 74, the shaft of the power screw and the interior of the housing. The lip seal formations are paired, with a first formation of each pair sliding against the interior of the generally tubular side wall of the housing and a second formation of each pair sliding against the exterior of the shaft. The lip seal formations are: a pair of outer or upper wiper seals 80 and a pair of inner or lower first gas seals 82 on the first piston seal 70; and a pair of outer or upper second gas seals 84 and a pair of inner or lower liquid seals 86 on the second piston seal 74.

The wiper seals 80 precede the associated gas seals 82 in the upward or outward direction of movement of the first piston seal 70 with respect to the interior of the housing 14. By doing so, the wiper seals 80 prevent contaminants such as dust and moisture from distorting or damaging the gas seals 82. The wiper seals 80 also limit or prevent any air being drawn past the gas seals 82 during charging.

The stroke of the first piston seal 70 parallel to the central longitudinal axis 20 is entirely contained within the major tubular portion 42 of the main body of the housing 14. Conversely, the stroke of the second piston seal 74 parallel to the central longitudinal axis 20 is entirely contained within the minor tubular portion 44 of the main body of the housing 14.

The open upper or outer end of the shaft 58 of the power screw 5 is sealed by a valve 84 comprising an annular resilient valve seal 86 and a hollow rigid tubular actuation stem 88. The stem 88 extends through the valve seal 86 such that a liquid-tight seal is maintained between the stem 88 and the valve seal 86 while enabling relative axial and circumferential movement of the valve seal 86, with the power screw 56, around the stem 88.

The stem 88 is closed at its lower or inner end where it extends beyond the valve seal 86 into the tubular shaft 58 of the power screw 56. The upper or outer end of the stem 88 is inserted into the boss 32 of the dispense head 16 and is open so that the hollow interior of the stem 88 communicates with the nozzle channel 30 in the dispense head 16. An annular stop encircling the stem limits the depth of insertion of the stem into the boss 32.

The configuration of the gas spring pump 10 defines three separate annular spaces between the shaft 58 of the power screw 56 and the generally tubular side wall of the housing 14, as follows:
firstly, a sealed variable-volume liquid chamber 90 is defined between the shaft of the power screw 58, the side wall of the housing 14, the base wall 46 of the housing 14 and the liquid seals 86 of the second piston seal 74;
secondly, an unsealed upper space 92 is defined between the shaft 58 of the power screw 56, the side wall of the housing 14, the annular retainer disc 40 and the wiper seals 80 of the first piston seal 70; and
thirdly, a sealed variable-volume gas chamber 94 is defined between the shaft 58 of the power screw 56, the side wall of the housing 14 and the first and second pairs of gas seals 82, 84 of the first and second piston seals 70,74 respectively.

As the axial position of the second piston assembly 66 along the power screw 56 partially defines the volumes of both the liquid chamber 90 and the gas chamber 94, it will be apparent that expansion of the gas chamber 94 is accompanied by compression of the liquid chamber 90 and vice versa.

By virtue of the aforementioned step between the minor tubular portion 44 and the major tubular portion 42, different diameters of those portions can be chosen to provide differential volumes for the gas chamber 94 relative to the liquid chamber 90 for a given stroke length.

As best seen in FIG. 2, a pinhole aperture 96 penetrates the tubular wall of the shaft 58. That aperture 96 is located near the bottom of the shaft 58, just above its inner or lower closed end. The aperture 96 is therefore positioned to be opened and closed by the radially-inward side of the second piston seal 74 as that seal slides along the shaft while the second piston assembly 66 reciprocates within the minor tubular portion 44 of the main body of the housing 14.

The aperture 96 communicates between the liquid chamber 90 and the hollow interior of the shaft 58. This allows liquid to flow under pressure from the chamber 90 into and up the shaft 58 whenever the aperture 96 is opened by movement of the second piston assembly 66 away from the aperture 96.

Similarly, the actuation stem 88 has a pinhole aperture 98 in its side wall near its inner or lower closed end. When the dispense head 16 is depressed, the stem 88 is pressed downwardly or inwardly through the surrounding valve seal 86 until the aperture 98 clears the valve seal 86. Then, the aperture 98 communicates between the hollow interior of the power screw 56 and the hollow interior of the stem 88. This allows liquid introduced into the hollow interior of the power screw 56 to flow under pressure through the stem 88 and into the nozzle path 30 to be dispensed through the nozzle 28 as a spray.

FIG. 3 shows an embodiment of the invention comprising the pump mechanism shown in FIGS. 1 and 2 where the dispense head 16 is encircled by an actuation sleeve 97. The actuation sleeve 97 is engaged with the dispense head 16 so that they rotate together. The actuation sleeve 97 incorporates an opening through which fluid may be ejected from the nozzle 28.

The actuation sleeve 97 may be fixedly engaged with the dispense head 16 so that the actuation sleeve 97 reciprocates in an axial direction along the longitudinal axis 20 with the dispense head 16 when the dispense head 16 is depressed to dispense liquid product. Alternatively, the actuation sleeve 97 and the dispense head 16 may be engaged such that the actuation sleeve 97 remains stationary while the dispense head reciprocates along the longitudinal axis 20 when the dispense head 16 is depressed to dispense liquid product.

The increased radial diameter of the actuation sleeve 97 allows greater torque to be applied to the dispense head 16, and hence the power screw 56. An actuation sleeve 97 may also be used for aesthetic reasons as part of the packaging of the device.

An optional separate actuation button 27 may be used that contacts, and at least in part, reciprocates in the longitudinal direction 20 with, the top wall 26 of the dispense head 16. The separate actuation button 27 may be used in conjunction with an actuation sleeve 97 as shown in FIG. 3. Alternatively, the separate actuation button 27 may be connected to the dispense head 16 without the need for an actuation sleeve 97.

Having described the components of the gas spring pump 10, the method of operation will now be defined with reference to FIGS. 1 to 5.

The gas spring pump 10 of the invention operates by way of a preliminary charging action, followed by a secondary dispensing action. The dispensing action may immediately follow the charging action, or there may be a delay between those actions. A single, or full, dispensing action or a plurality of smaller, or partial, dispensing actions may be performed following a single charging action, before another charging action is performed.

A resting, uncharged, or zero charge position of the gas spring pump 10 is defined by the piston assemblies 64, 66 being maximally displaced from each other axially along the power screw 56. This maximises the volume of the gas chamber 94 as shown in FIG. 1. Consequently, the liquid chamber 90, whose volume is determined by the axial position of the second piston assembly 66, is empty or at a minimal volume.

During charging, a user grips and turns the dispense head 16 relative to the housing 14 and the container 12. The toothed engagement of the, or each, inwardly-protruding lug 24 on the dispense head 16 with the teeth 62 around the head 60 of the power screw 56 results in the dispense head 16 and power screw 56 turning together.

Turning the power screw 56 relative to the housing 14 drives the piston assemblies 64, 66 towards each other in opposite axial directions along the shaft 58 of the power screw 56 by virtue of the complementary mutually-opposed helical threads. Additionally, upward or outward movement of the second piston assembly 66 opens the pinhole aperture 96 in the tubular wall of the shaft 58.

The converging movement of the piston assemblies compresses 64, 66, and thereby pressurises, air or other gas trapped in the sealed gas chamber 94. The pressurised gas volume biases the piston assemblies 64, 66 apart. In this way, the compressed gas in the gas chamber 94 acts as a positive-pressure air spring.

Simultaneously with pressurisation of gas in the gas chamber 94, upward or outward movement of the second piston assembly 66 along the longitudinal axis of the shaft 58 expands the liquid chamber 90 thereby drawing down a partial vacuum within. That negative pressure draws liquid to be dispensed from the container 12 into the liquid chamber 90 via the dip tube 52 and the one-way valve 54 in the opening 48 in the base wall of the housing 46.

The power screw 56 continues to turn until the piston assemblies 64, 66 reach the ends of the respective threads on the power screw 56 or until the piston assemblies 64, 66 encounter each other and block further movement. Gas in the gas chamber 94 is now maximally compressed, which tends to urge the piston assemblies 64, 66 apart when the user releases their grip on the dispense head 16. As the piston assemblies 64, 66 are constrained to move longitudinally within the housing 14 and not to turn within the housing 14, such movement of the piston assemblies 64, 66 will cause the power screw 56 and hence the dispense head 16 to counter-rotate. Such counter-rotational movement is restricted by the back-pressure of the fluid in the device. Optionally, counter-rotation may be prevented by engagement of a rotation lock (not shown) acting on the power screw 56 or the dispense head 16.

The gas spring pump 10 is now in a charged state (FIG. 2).

The piston assemblies 64, 66 will be urged apart by the high pressure of gas in the gas chamber 94 defined between them. In particular, downward or inward movement of the second piston assembly 66 will reduce the volume of the liquid chamber 90 and hence will pressurise liquid previously drawn into that chamber. This pressure forces some of the liquid through the now-open pinhole aperture 96 and into the hollow interior of the shaft 58. Any air trapped between the liquid within the shaft 58 and the stem 88 that seals against the valve seal 86 is also compressed. The system is pressurised ready for dispensing. Further movement of the piston assemblies 64, 66 is prevented by the back-pressure of the fluid in the system.

To dispense the compressed liquid, a user depresses the dispense head 16 by pressing it downwardly against the restoring force of the helical spring 18. This downward movement of the dispense head 16 has two effects.

Firstly, as shown in FIG. 4, downward movement of the dispense head 16 causes the, or each, lug 24 protruding inwardly within its skirt 22 to move below the level of, and out of engaging contact with, the teeth 62 surrounding the head 60 of the power screw 56. The power screw 56 is now free to turn relative to, and without rotation of, the dispense head 16.

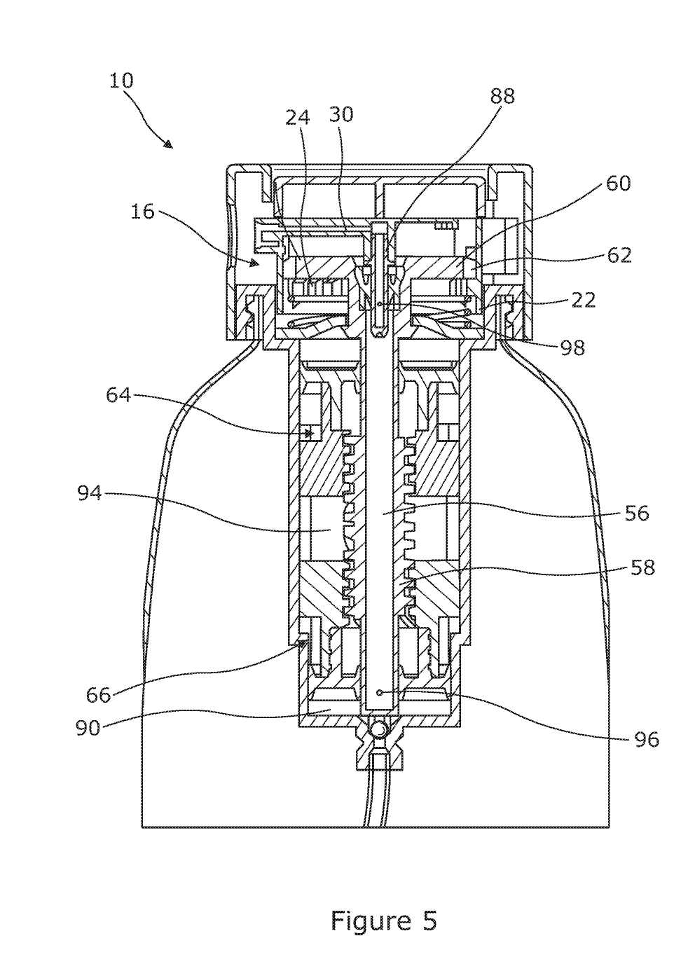

Secondly, as best shown in FIG. 5, downward movement of the dispense head 16 moves the actuation stem 88 downwardly. This exposes the pinhole aperture 98 in the side wall of the stem 88 to the hollow interior of the shaft 58 of the power screw 56. This establishes a flowpath for the liquid to be dispensed extending from the liquid chamber 90 to the nozzle 28 via the pinhole aperture 96 and the hollow interior of the shaft 58. With the back-pressure released, the piston assemblies 64, 66 are free to move apart under the biasing force of the gas pressure in the gas chamber 94. Initially any air trapped between the liquid within the shaft 56 and the stem 88 will be expelled through the nozzle 28 under pressure of the liquid beneath. As the piston assemblies 64, 66 continue to move apart, the second piston assembly 66 further pressurises the liquid in the liquid chamber 90, which liquid is prevented from returning to the container by the one-way valve 54. Under this pressure, further liquid flows through the pinhole aperture 96 in the tubular shaft 58 of the power screw 56 and up the hollow interior of the shaft 58 to be dispensed eventually through the nozzle 28. When the liquid fills the hollow interior of the shaft 56 and enters the nozzle path 30 via the hollow interior of the stem 88, that liquid will be expelled from the nozzle 28 under pressure as a spray.

Typically, disengagement of the lugs 24 on the dispense head 16 and the teeth 62 on the head of the power screw 56, precedes exposure of the pinhole aperture 98 to allow for pressurisation of the system prior to the start of dispensing to ensure a strong, full spray is achieved from the outset, although step these may be simultaneous.

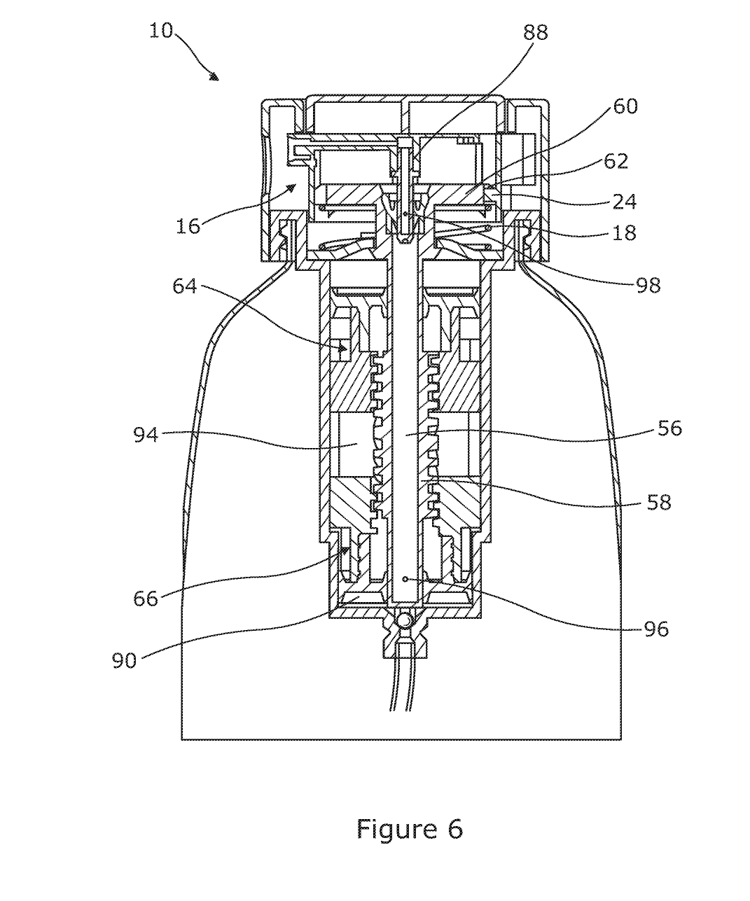

As shown in FIG. 6, when the user removes the applied downward pressure on the dispense head 16, the dispense head 16 moves upwardly to return to its extended position under the influence of the biasing helical spring 18. Upward movement of the dispense head 16 raises the actuation stem 88 so that its pinhole aperture 98 is closed by the valve seal 86. This closes the flowpath of the liquid to be dispensed. Advantageously, this ensures a sharp cut-off in the dispensing flow, which prevents undesirable spray characteristics towards the end of the dispensing action such as a weak spray or dribbling. The back-pressure of the fluid in the system prevents further rotation of the power screw 56. Engagement of the teeth 62 on the head 50 of the power screw 56 with the, or each, inwardly-protruding lug 24 of the dispense head 16 then locks the power screw 56 relative to the dispense head 16. If the gas spring pump 10 has only been partially discharged at this stage, further dispensing of liquid is possible if the dispense head 16 is depressed again.

On full discharge of the gas spring pump 10, the pinhole aperture 96 in the tubular shaft of the power screw 56 is covered by the second piston seal 74 as it advances in a downward or inward direction. This also ensures a sharp cut-off in the dispensing flow to prevent undesirable spray characteristics towards the end of the dispensing action.

Once the gas spring pump 10 is fully discharged, it may be re-charged by repeating the charging procedure described above.

Advantageously, the two-piston arrangement of this embodiment of the invention provides for a shorter stroke length of an individual piston assembly for a given charging pressure. This enables a shorter turn of the power screw to generate a given amount of pressure, albeit with an increase in torque required to turn the power screw.

FIGS. 7 and 8 show an alternative embodiment of the gas spring pump according to the present invention. It should be noted that the gas spring pump 110 shown in FIGS. 7 and 8 has several components in common with the gas spring pump 10 described above with reference to FIGS. 1 and 2.

In this embodiment, the generally tubular housing 112 supports and surrounds a single piston assembly 114 engaged on a power screw 116. The piston assembly 114 surrounds the power screw 116 and is engaged with the power screw 116 by virtue of a male thread on the power screw and a complementary female thread on the piston assembly 114.

The body of the housing 112 is internally splined with one or more longitudinally-extending ribs that engage with one or more complementary grooves on the outer side of the piston assembly to prevent the piston assembly turning within the housing 112.

The helical threads of the power screw 116 and the piston assembly 114 are arranged such that on rotation of the power screw 116 around the central longitudinal axis 118, the piston assembly 114 moves axially along the power screw 116. Again, the piston assembly 114 comprises a rigid piston body 120 and a resilient piston seal 122.

The shapes of the piston body 120, the piston seal 122 and the surrounding housing 112, and how they interact with each other, are largely the same as for the second piston assembly 66 and the housing 14 of the preceding embodiment. However, in this embodiment, the tubular skirt 124 is elongated, compared to the embodiment shown in FIGS. 1 and 2, to accommodate a longer stroke of the piston seal 122. The minor portion of the housing 128 is similarly elongated for the same reason.

The piston seal 122 has lip seal formations that extend axially in the direction of relative movement between the piston seal 122, the shaft 130 of the power screw 116 and the interior of the housing 112. The lip seal formations are paired, with a first formation of each pair sliding against the interior of the generally tubular side wall of the housing 112 and a second formation of each pair sliding against the exterior of the shaft 130 of the power screw 116. Specifically, the lip seal formations on the piston seal 122 are a pair of outer or upper gas seals 132 and a pair of inner or lower liquid seals 134.

The stroke of the piston seal 122 is entirely contained within the minor tubular portion of the main body of the housing 128. The major tubular portion of the main body of the housing 136 surrounds and supports the head 138 of the piston body 120 through the entire length of this stroke.

In this embodiment, the annular retainer disc 140 is hat-shaped, comprising a generally planar ring and a downwardly-opening recess surrounding the central hole on the central longitudinal axis 118. The recess is defined by a base wall 142, which now contains the central hole on the longitudinal axis 118, and a surrounding side wall 144.

An annular inner seal 146 is seated within the recess and surrounds the shaft 130 of the power screw 116. The inner seal 146 comprises an outer wall that bears against, and forms a circumferential gas-tight seal with, the side wall 144 of the recess. The inner seal 146 further comprises inner lip seal formations that extend axially along, and bear against, the shaft 130 of the power screw 116 to maintain a gas-tight seal between the seal 146 and shaft 130. The lip seal formations on the inner seal are a lower or inner primary gas seal 148 and an outer or upper secondary gas seal 150.

The retainer disc 140 is seated on an O-ring 152 that is seated, in turn, in an annular groove in the outer or upper side of the radially-extending shoulder 154 of the housing. This forms a gas-tight seal between the retainer disc 140 and the housing 112.

As in the embodiment above, at the junction between the shaft 130 and the head 156 of the power screw 116, the shaft 130 is radially enlarged to define a radially-extending flange 158 shaped to snap-fit under the retainer disc 140 around the edge of the central hole. The helical spring 160 bears against the underside of the head 156 of the power screw 116 to bias the flange 158 against the retainer disc 140.

The configuration of the gas spring pump 110 defines two separate annular spaces between the shaft 130 of the power screw 116 and the generally tubular side wall of the housing 112, as follows:
firstly, a sealed variable-volume liquid chamber 160 is defined between the shaft 130 of the power screw 116, the side wall of the housing 112, the base wall of the housing 162 and the liquid seals 134 of the piston seal 122;
secondly, a sealed variable-volume gas chamber 164 is defined between the shaft 130 of the power screw 116, the side wall of the housing 112, the gas seals 132 of the piston seal 122, and the annular retainer disc 140 that is sealed to the shaft 130 and to the housing 112.

The actions of charging and dispensing this embodiment of the gas spring pump 110 share features with the method of charging the gas spring pump 10 described above and shown in FIGS. 1 to 2. For conciseness, only those features that differ are described in detail.

As for the embodiment above, during charging, the power screw 116 is turned by a user gripping and turning the dispense head 166, either directly or via an actuation sleeve, relative to the housing 112 and the container 148. Turning the power screw 116 relative to the housing 112 drives the piston assembly 114 upwards along the shaft of the power screw 116 by virtue of the complementary mated helical threads. As for the previous embodiment, upward or outward movement of the piston assembly 114 opens the pinhole aperture 170 in the tubular wall of the shaft 130.

The upward movement of the piston assembly 114 compresses, and thereby pressurises gas in, the sealed compressible gas chamber 164. The pressurised gas in the gas chamber 164 biases the piston assembly 114 downwards, thereby acting as a positive pressure air spring.

As in the previous embodiment, simultaneously with pressurisation of the gas chamber 164, upward longitudinal movement of the piston assembly 114 along the shaft 130 of the power screw 116 draws liquid into the liquid chamber 160. Liquid is drawn from the container 148 via the dip tube 172 and the one-way valve 174 in the opening 175 in the base wall 162 of the housing 112.

The power screw 116 continues to turn until the piston assembly 114 reaches the end of the thread on the power screw 116 or until the piston assembly 114 encounters the retainer disc 140. Gas in the gas chamber 164 is now maximally compressed, which tends to drive the piston assembly 114 inward or downward when the user releases the dispense head 166.

As for the above embodiment, the back pressure of the fluid in the system resists any tendency of the power screw 116, and hence the dispense head 166, to counter-rotate when the user releases their grip on the dispense head 166. Optional engagement of a rotation lock (not shown) on the dispense head 166 or power screw 116 may also be used to prevent counter-rotation the dispense head 166.

The gas spring pump 110 is now in a charged state (FIG. 4).

The discharge action is similar to that of the gas spring pump 10 of the preceding embodiment. In brief, to dispense the compressed liquid, a user depresses the dispense head 166 by pressing it downwardly against the restoring force of the helical spring 160 to:
(a) move the, or each, inwardly-protruding lug 182 within the skirt of the dispense head 166 out of engagement with the teeth 186 surrounding the head 156 of the power screw 116. With the power screw 116 now free to turn relative to the dispense head 166, the piston assembly is free to move inwardly or downwardly under the biasing force of the gas pressure in the gas chamber 164 to pressurise the liquid in the liquid chamber 160; and
(b) establish a flowpath for the liquid to be dispensed extending from the liquid chamber 160 to the nozzle 176, by exposing the pinhole aperture 178 of the stem 180 to the hollow interior of the shaft 130 of the power screw 116 by downward movement of the stem 180.

Typically, step (a) precedes step (b) to allow for pressurisation of the system prior to the start of dispensing to ensure a strong, full spray is achieved from the outset, although step (a) and step (b) may be simultaneous.

The dispense head may be depressed directly by the user or via an actuation button as for the embodiment described above.

As the piston assembly 114 descends, the liquid in the liquid chamber 160, prevented from returning to the container by the one-way valve 174, flows through the pinhole aperture 170 in the tubular shaft 130 of the power screw 116 and up the hollow interior of the shaft 130 to be dispensed eventually through the nozzle 176.

When the user releases the dispense head 166, the dispense head 166 moves upwardly to return to its extended position under the influence of the biasing helical spring 160. This closes the flowpath of the liquid to be dispensed. It also locks the power screw 116 relative to the dispense head 166 by engaging the teeth 186 on the head 156 of the power screw 116 with the, or each, inwardly-protruding lug 182 of the dispense head 166.

As for the embodiment above, on full discharge of the gas spring pump 110, the pinhole aperture 170 in the tubular shaft 130 of the power screw 116 is covered by the piston seal 122 as it advances in a downward or inward direction. This also ensures a sharp cut-off in the dispensing flow to prevent undesirable spray characteristics towards the end of the dispensing action.

Once the gas spring pump 110 is fully discharged, it may be re-charged by repeating the charging procedure described above.

Advantageously, the inner seal 146 of the retainer disc 140 is required to seal only in rotation rather than in a combination of rotation and axial movements. This makes the inner seal 146 more effective and more robust.

The above embodiments bias the respective piston assemblies by means of a positive pressure generated by compressing gas in a sealed gas chamber 164.

In positive-pressure gas spring pumps having an ‘at rest’ pressure that is at or close to ambient pressure, there remains a challenge in achieving the desired charging characteristics, and spray performance, throughout the entire duration of the dispense action. For example, in such systems, there can be a substantial pre-charge movement in which movement of the piston assemblies creates little increase in pressure. Similarly, after charging followed by a release of pressure in the gas volume toward ambient pressure, there can be poor dispensing performance towards the end of the discharge action, for example, low-pressure spray and dribbling.

To achieve a sustained and powerful spray from the nozzle throughout most or all of the dispense action, the gas in the gas chamber 164 must be compressed to a high positive pressure during the charging action. To generate such high pressure, the user must apply to the dispense head either: (a) a smaller turn with relatively high torque, or (b) a larger turn with relatively low torque. For comfortable manual operation, both low torque and a short turn, preferably less than 360°, are required for ease of hand operation. It is therefore necessary to find a balance between these two requirements.

To reduce the torque necessary in the charging turn, the pitch of the threads of the power screw and the piston assemblies may be decreased. However, this requires increased rotation to charge the device.

Another way to achieve the desired balance is to vary the dimensions of the gas chamber. For narrow piston assemblies, for example, for piston assemblies with a diameter in the order of 10 mm to 30 mm, a longer stroke would be required to generate a given pressure when compared with equivalent larger-diameter pistons, for example, piston assemblies with a diameter in the order of 70 mm to 100 mm. The longer stroke of a narrow piston would reduce the torque required, but again at the expense of increased rotation. Conversely, the shorter piston stroke for a larger diameter would increase the torque required to turn the dispense head, but would have the advantage of a shorter turn.

Another design consideration is the size and proportions of the gas pump mechanism and their effect upon the container to which the mechanism is fitted. For example, a wide piston assembly may not fit with commercially-acceptable container designs that are required to fit comfortably in the user's hand. Conversely, a narrow, long-stroke piston assembly may be too tall for use with commercially-acceptable container designs, bearing in mind the need for shelf height clearance. Also, the space occupied by the gas pump mechanism may impact upon the volume available for the liquid being dispensed, to the extent that the gas pump mechanism extends into a container for holding that liquid.

In some embodiments of the present invention, the gas volume in the gas chamber may be pre-charged to above ambient pressure. Pre-charging of the gas volume may be achieved during assembly, for example by assembly at an elevated pressure. With suitable selection of other design parameters, for example the pitch of the helical threads on the power screw, pre-charging the gas volume allows the desired maximum operating pressure to be achieved with a short stroke and acceptable torque.

Negative-Pressure or Vacuum Spring Pumps

A further alternative approach for a gas spring pump in accordance with the invention is to use a below-ambient or negative-pressure gas spring. For brevity, the following description will refer to pumps using such springs as vacuum spring pumps.

Vacuum spring pumps generally exhibit a very flat pressure curve that is relatively constant from close to the zero- or non-charged state to the full charge state. Furthermore, a significant proportion of the maximum negative pressure is achieved only after a small initial charging movement.

A vacuum gas spring pump 210 according to the present invention is shown in FIGS. 9 to 11. A housing 212 of the pump 210 comprises a lower pump body 214 and an upper pump body 216. The pump 210 further comprises a dispense head, a helical spring, and optionally an actuation sleeve and actuation button, that are not shown in these figures but may be of similar design and function to the corresponding features of the preceding embodiments. The lower pump body 214 and upper pump body 216 are each rotationally symmetrical about a common central longitudinal axis 218 that lies in a generally vertical orientation when the pump 210 is oriented for use.

The lower pump body 214 has an outer tubular wall 220 and an inner tubular wall 222 in concentric relation about the central longitudinal axis 218. The outer tubular wall 220 and the inner tubular wall 222 are joined at their respective lower or inner ends by a generally circular base wall 224. The outer tubular wall 220 upstands from the radially-outer periphery of the base wall 224 and the inner tubular wall 222 extends from the base wall 224 in parallel from a radially-inner part of the base wall 224. In conjunction with the base wall 224 that joins them, the outer tubular wall 220 and the inner tubular wall 222 define an annular trough 226 between them. In conjunction with the base wall 224, the inner tubular wall 222 defines a central well 228.

As for the positive-pressure embodiments shown in FIGS. 1 to 4, the base wall 224 of the lower pump body 214 has a central opening 229 containing a one-way valve 230 that communicates with a dip tube (not shown) attached to the exterior of the base wall 224.

The vacuum spring pump 210 can attach to a container with the addition of suitable formations on the radially-outer side of the lower pump body 214. In this configuration, most of the pump 210 protrudes from the container to maximise the volume available in the container for liquid to be dispensed.

The upper pump body 216 is positioned upwardly or outwardly of the lower pump body 214 such that both are centred on their common central longitudinal axis 218. The upper pump body 216 is retained on the lower pump body 214 by resilient snap fittings 234.

The upper pump body 216 is hollow and is generally frusto-conical, tapering to a central hole at the outer or upper end on the central longitudinal axis 218. The hole accommodates an elongate shaft 236 of a power screw 238 of similar design and function to the power screw 56, 116 of the preceding embodiments. Thus, at its closed inner or lower end, the elongate shaft 236 of the power screw 238 extends to, and bears against, the base wall 224 of the lower pump body 214. Surrounding its outer or upper open end, the elongate shaft 236 of the power screw 238 has a screw head 240 that lies outside the housing 212, to lie within a hollow dispense head 242.

The upward taper of the upper pump body 216 fits within the dispense head 242 that surrounds the head 240 of the power screw 238. As in the preceding embodiments, inwardly-protruding lugs 244 of the dispense head 242 engage teeth 246 surrounding the head 240 of the power screw 238.

Again, at the junction between the shaft 236 and the head 240 of the power screw 238, the shaft is radially enlarged to define a radially-extending flange 248. In this case, the flange 248 snap-fits with the upper pump body 216 under the edge of the central hole.

As in the preceding embodiments, the pump housing 212 surrounds and supports a piston assembly 250 comprising a piston body 252 that surrounds and is engaged with the power screw 238. For this purpose, the power screw 238 has a male thread and the piston body 22 has complementary female threads. In this embodiment, the piston assembly 250 further comprises a resilient annular inner piston seal 254 and a resilient annular outer piston seal 256 supported by the rigid piston body 252.

To prevent rotation of the piston assembly 250 in the housing 212, the piston body 252 and upper pump body 216 have engaging longitudinal formations. In this embodiment, these formations are slots or holes 258 in the piston body 252 through which protrusions 260 on the upper pump housing penetrate (FIGS. 9 to 11).

As in preceding embodiments, the piston body 252 is shaped to define a tubular skirt 262 that receives and supports the inner piston seal 254. In this embodiment, the piston body 252 further comprises a downwardly-depending, open-bottomed, frusto-conical outer skirt 264 that is joined at its apex to the upper or outer end of the piston body 252, and widens to an outer seal support 266 at its lower or inner end. The outer seal support 266 is generally parallel to, and concentrically arranged around, the tubular skirt 262. The outer piston seal 256 is retained on the outer seal support by resilient snap connectors 268 that are received in complementary slots 270 in the outer piston seal 256.

The inner piston seal 254 has lip seal formations that extend axially in the direction of relative movement between the inner piston seal 254, the shaft 236 of the power screw 238 and the interior of the inner tubular wall 222. The lip seal formations are paired, with a first formation of each pair sliding against the interior of the inner tubular wall 222 and a second formation of each pair sliding against the exterior of the shaft 236. The lip seal formations on the inner piston seal 254 are: a pair of outer or upper wiper seals 272 and a pair of inner or lower liquid seals 274.

The wiper seals 272 precede the associated liquid seals 274 in the upward or outward direction of movement of the inner piston seal 254 with respect to the interior of the housing 212. Again, by doing so, the wiper seals 272 prevent contaminants such as dust from distorting or damaging the liquid seals 274. The wiper seals 272 also prevent any air being drawn past the liquid seals 274 during charging.

The outer piston seal 256 has a pair of lip seal formations, namely a pair of outer or upper gas seals 276, which extend axially in the direction of relative movement between the outer piston seal 256, the exterior of the inner tubular wall 222 and the interior of the outer tubular wall 220. A radially inner formation of the pair slides against the exterior of the inner tubular wall 222 and a radially outer formation of the pair slides against the interior of the outer tubular wall 220.

The stroke of the inner piston seal 254 parallel to the central longitudinal axis 218 is entirely contained within the central well 228 of the lower pump body 214. The stroke of the outer piston seal 256 parallel to the central longitudinal axis 218 is entirely contained within the annular trough 226 of the lower pump body 214.

A valve seal 278 in the open upper or outer end of the shaft 236 of the power screw 238 and an actuation stem 280 that extends through the valve seal 278 are largely the same as for the preceding embodiments in their shape and in how they interact with each other.

The configuration of the gas spring pump 210 defines two separate annular spaces between the shaft 236 of the power screw 238 and the outer tubular wall 220 of the lower pump body 214, as follows:
firstly, a sealed variable-volume liquid chamber 282 is defined in the central well 228 between the shaft 236 of the power screw 238, the interior of the inner tubular wall 222 of the lower pump body 214, the base wall 224 of the lower pump body 214 and the liquid seals 274 on the inner piston seal 254; and
secondly, a negative-pressure gas or vacuum chamber 284 is defined in the annular trough between the exterior of the inner tubular wall 222 of the lower pump body 214, the interior of the outer tubular wall 220 of the lower pump body 214, the base wall 224 of the lower pump body 214 and the gas seals 276 of the outer piston seal 256.

As for the preceding embodiments, and as best seen in FIGS. 9 and 10, a pinhole aperture 286 through the tubular wall of the shaft 236 is positioned to be opened and closed by the radially-inward side of the inner piston seal 254 as that seal slides along the shaft 236. The aperture 286 communicates between the liquid chamber 282 and the hollow interior of the shaft 236. The actuation stem 280 received in the valve seal 278 also has a pinhole aperture 288 in its side wall so that when the dispense head 242 is depressed, there is fluid communication between the hollow interior of the power screw 238 and the hollow interior of the stem 280.

In a variant of the above embodiment, rotation of the piston assembly in the housing is prevented by rails 297 on the inside of the upper pump body that engage with complementary channels 299 on the piston body (FIGS. 12 to 14).

Having described the components of the vacuum spring pump, the method of operation will now be defined with reference to FIGS. 9 to 10.

The actions of charging and dispensing the vacuum spring pump share features with the method of charging the positive-pressure gas spring pump described above and shown in FIGS. 1 to 4. For conciseness, only those features that differ are described below in detail.

A resting, uncharged, or zero charge position of the gas spring pump 210 is defined by the piston assembly 250 being maximally displaced downwardly or inwardly along the power screw 238. This minimises the volume of the vacuum chamber as shown in FIG. 9. Consequently, the liquid chamber 282, whose volume is also determined by the axial position of the piston assembly 250, is also empty or at a minimal volume.

As for the preceding embodiments, during charging, the power screw 238 is turned by a user gripping and turning the dispense head 242 relative to the housing 212 and the container. This turns the power screw 238 relative to the housing 242, which drives the piston assembly 250 upwardly or outwardly along the shaft 236 of the power screw 238 by virtue of the mated helical threads. As for the above embodiments, upward or outward movement of the piston assembly 250 opens the pinhole aperture 286 in the tubular wall of the shaft 236.

Expansion of the sealed vacuum chamber 284 due to the upward movement of the piston assembly 250 generates a partial vacuum within that chamber. The below-atmospheric or negative pressure of the gas within the vacuum chamber 284 biases the piston assembly 250 inwardly or downwardly, thereby acting as a negative-pressure air spring.

As in the previous embodiments, simultaneously with generating a partial vacuum within the vacuum chamber 284, upward longitudinal movement of the piston assembly along the shaft 236 of the power screw 238 draws liquid to be dispensed into the liquid chamber 282. Liquid is drawn from the container via the dip tube (not shown) and the one-way valve 230 in the opening 229 in the base wall 224 of the housing 212.

The power screw 238 continues to turn until the piston assembly 250 reaches the end of the thread on the power screw 238 or until the piston assembly 250 encounters the top of the upper pump body 216. The pressure of the gas in vacuum chamber 284 is now at a minimum, which biases the piston assembly 250 inwardly or downwardly when the user depresses the dispense head 242. As for the above embodiment, the back-pressure of the fluid resists any tendency of the power screw 238, and hence the dispense head 242, to counter-rotate when the user releases their grip on the dispense head 242. Optional engagement of a rotation lock (not shown) on the dispense head 242 or power screw 238 may also be used to prevent counter-rotation of the dispenses head 242.

The vacuum spring pump 210 is now in a charged state (FIG. 10).

The discharge action is similar to that of the positive-pressure gas spring pump 110 of the preceding embodiments. In brief, to dispense compressed liquid, a user depresses the dispense head 242 by pressing it downwardly against the restoring force of the helical spring (not shown) to:
(a) move the, or each, inwardly-protruding lug 244 within the skirt 294 of the dispense head 242 out of engagement with the teeth 246 surrounding the head 298 of the power screw 238. With the power screw 238 now free to turn relative to the dispense head 242, the piston assembly 250 is free to move inwardly or downwardly under the biasing force of the negative pressure of the gas in the vacuum chamber 284 to pressurise the liquid in the liquid chamber 282; and
(b) establish a flowpath for the liquid to be dispensed extending from the liquid chamber 282 to the nozzle 290, by exposing the pinhole aperture 286 of the stem to the hollow interior of the shaft 236 of the power screw 238 by downward movement of the stem 280.

Typically, step (a) precedes step (b) to allow for pressurisation of the system prior to the start of dispensing to ensure a strong, full spray is achieved from the outset, although step (a) and step (b) may be simultaneous.

The dispense head may be depressed directly by the user or via an actuation button as for the embodiment described above.

As the piston assembly 250 descends, the liquid in the liquid chamber 282, prevented from returning to the container by the one-way valve 230, flows through the pinhole aperture 286 in the tubular shaft of the power screw 238 and up the hollow interior of the shaft 236 to be dispensed eventually through the nozzle 290.

When the user releases the dispense head 242, the dispense head 242 moves upwardly to return to its extended position under the influence of the biasing helical spring (not shown). This closes the flowpath of the liquid to be dispensed. It also locks the power screw 238 relative to the dispense head 242 by engaging the teeth 296 on the head 240 of the power screw 238 with the, or each, inwardly-protruding lug 244 of the dispense head 242.

As for the embodiment above, on full discharge of the gas spring pump 210, the pinhole aperture 286 in the tubular shaft 236 of the power screw 238 is covered by the inner piston seal 254 as it advances in a downward or inward direction to ensure a sharp cut-off in the dispensing flow.

Once the vacuum spring pump 210 is fully discharged, it may be re-charged by repeating the charging procedure described above.

A further embodiment of a negative-pressure or vacuum spring pump is shown in FIGS. 15 and 16. The vacuum spring pump 310 has some components in common with the vacuum spring pump described above with reference to FIGS. 9 to 14.

As in the preceding embodiment, the lower pump body 312 has an outer tubular wall 314 and an inner tubular wall 316 in concentric relation about the central longitudinal axis 318. The outer tubular wall 314 and the inner tubular wall 316 are again joined at their respective lower or inner ends by a generally circular base wall 320. An annular trough 322 is defined between the outer tubular wall 314 and the inner tubular wall 316, whereas the inner tubular wall 316 surrounds a central well 323 within the annular trough 322. The base wall 320 has a central opening 324 containing a one-way valve 326 that controls the flow of liquid through that opening.

The dispense head 328, helical spring, central power screw 332, actuation valve 334, and optional actuation sleeve and actuation button are common to the embodiment shown in FIGS. 9 to 14. The helical spring has been omitted from FIGS. 15 and 16 for clarity.

As in the preceding embodiments, the pump housing surrounds and supports a piston assembly 340 comprising a piston body 342 that surrounds and is threadedly engaged with the power screw 332. In this case, an alternative engagement of the mated helical threads of the power screw 332 and piston assembly 340 is shown where the interior of the piston body 342 is fully threaded along its length whereas the complementary external thread of the power screw 332 is relatively short.

As in the embodiment shown in FIGS. 9 to 14, the piston assembly 340 further comprises a resilient annular inner piston seal 344 and a resilient annular outer piston seal 346 supported by the rigid piston body 342. The piston body 342 also comprises concentric inner 348 and outer 350 skirts.

As best seen in FIG. 15, in this embodiment the outer skirt 350 of the piston body 342 lies generally parallel to the inner skirt 348 to define a downwardly-facing annular recess 352. That recess receives and closely embraces the inner tubular wall of the lower pump body 312 when the pump 310 is in a resting, zero-charge position (FIG. 15). The recess 352 also guides reciprocal motion of the piston body 342 with respect to the inner tubular wall 316 as the piston body 342 moves longitudinally along the power screw 332 in use (FIGS. 15 and 16).

The interior of the outer skirt 350 is internally splined with one or more longitudinally-extending ribs that engage with one or more complementary grooves on the outer side of the inner tubular wall 352. This prevents the piston assembly 340 turning within the housing 338 and so constrains the piston assembly 340 to move only longitudinally with respect to the housing 338.

A flange 354 extends radially outwardly from the lower or inner end of the outer skirt 350 toward the outer tubular wall 314. The flange 354 is supported by circumferentially-spaced buttresses 356 between the flange 354 and the outer skirt 350. At its outermost extremity, the flange 354 has an upstanding lip 358 to which a lip seal 360 is mounted or overmoulded. The lip seal 360 extends upwardly or outwardly and is biased against, and forms a gas-tight seal with, the outer tubular wall 314. The lip seal 360 comprises an upper or outer gas seal 359. Unlike the preceding embodiment, no lip seal is provided on the radially-inner side of the flange 354.

The inner piston seal 344 has lip seal formations that extend axially in the direction of relative movement between the inner piston seal 344, the shaft 336 of the power screw 332 and the interior of the inner tubular wall 316. The lip seal formations are paired, with a first formation of each pair sliding against the interior of the inner tubular wall 316 and a second formation of each pair sliding against the exterior of the shaft 336. The lip seal formations on the inner piston seal 344 are a pair of outer or upper gas seals 361 and a pair of inner or lower liquid seals 363.

Thus, two separate annular spaces are disposed between the shaft of the power screw and the outer tubular wall of the lower pump body, as follows:
firstly, a sealed variable-volume liquid chamber 362 is defined between the shaft 336 of the power screw 332, the interior of the inner tubular wall 316 of the lower pump body 312, the base wall 320 of the lower pump body 312 and the liquid seals 363 on the inner piston seal 344; and
secondly, a negative-pressure gas or vacuum chamber 364 is defined between the exterior of the inner tubular wall 316 of the lower pump body 312, the interior of the outer tubular wall 314 of the lower pump body 316, the base wall of the lower pump body 312, the gas seal 359 of the lip seal 360 and the gas seals 361 of the inner piston seal 344.

Advantageously, this removes one sealing interface, which reduces the cost and complexity of manufacture and eliminates a potential source of failure.

The charging and dispensing actions of this embodiment are as for the preceding embodiment.

A further embodiment of a negative-pressure or vacuum spring pump is shown in FIGS. 17 to 18. The vacuum spring pump 410 has some components in common with the vacuum spring pumps 210, 310 described above with reference to FIGS. 9 to 16.

In this embodiment, the outer tubular wall 412 of the lower pump body 414 is radially outside the inner tubular wall 416 of the lower pump body 414 but is also axially displaced outwardly or upwardly from the inner tubular wall 416. A radially-extending shelf 418 joins the outer tubular wall 412 to the top or upper end of the inner tubular wall to confer a stepped profile on the lower pump body 414 in longitudinal section. The shelf 418 is directed radially inwardly moving in a downward or inward direction from the outer tubular wall 412 to the inner tubular wall 416. Circumferentially-spaced buttresses 420 between the underside of the shelf 418 and the exterior of the inner tubular wall 416 support the shelf 418.

The outer tubular wall 412 continues downwardly or inwardly from the shelf 418 to form a skirt portion 422. A concentric wall 424 radially-inward of the skirt portion 422 depends downwardly from the underside of the shelf 418, generally parallel to the skirt portion 422. A downwardly-facing annular groove 426 is defined between the skirt portion 422 and the parallel concentric wall 424. The groove 426 is configured to receive and seal to the neck of the container (not shown) as for earlier embodiments.

In contrast to the embodiment shown in FIGS. 9 to 16, the radially-inboard position of the groove 426 with respect to the outer tubular wall 412 allows the pump to protrude less outside the container.

The lower end of the inner tubular wall 416 is closed by a base wall 428. As for the preceding embodiments, the base wall 428 has a central opening 430 containing a one-way valve 432 to prevent the flow of liquid back into the container.

The dispense head, helical spring, central power screw 438, actuation valve, and optional actuation sleeve and actuation button are common to the embodiment shown in FIGS. 9 to 16. The dispense head, helical spring and actuation stem have been omitted from FIGS. 17 and 18 for clarity.

An upper pump body 442, here flattened to a disc, is positioned upwardly or outwardly with respect to the lower pump body 414 on a shared central longitudinal axis 416. Together the upper pump body 442 and the lower pump body 414 to form a pump housing 444. Again, the upper pump body 442 has a central hole on the central longitudinal axis 416 that accommodates the shaft 446 of a power screw 438. Also, at the junction between the shaft 446 and the head 448 of the power screw 438, a radially-extending flange 450 snap-fits under the upper pump body 442 around the edge of the central hole.

In this embodiment, the housing 444 surrounds and supports a single piston assembly 452 that surrounds and is threadedly engaged with the power screw 438. The piston assembly 452 comprises a piston body 454, a piston body sleeve 456 having an integral outer gas seal 458, and an inner piston seal 460 having inner gas lip seals 462 and inner liquid lip seals 464. The piston body 456 is T-shaped in longitudinal section as shown, having a radially-enlarged head portion 465 from which a narrower tubular skirt 466 depends.

The head portion 465 of the piston body 454 extends radially to an outer edge that is spaced slightly inwardly of the outer tubular wall 412 of the lower pump body 414. Here, the piston body 454 supports the outer gas seal 468 that is integral with the piston body sleeve 456. The outer gas seal 468 bears against the outer tubular wall 412 of the lower pump body 414 and forms a gas-tight seal between the piston body 454 and the outer tubular wall 412.

The piston body sleeve 456 sheathes the exterior of the piston body 454 and has a skirt portion 470 that extends downwardly or inwardly beyond the end of the tubular skirt 466 of the piston body 454 to receive the inner piston seal 460. The inner gas lip seals 462 of the inner piston seal 460 provide a gas-tight seal between the shaft 446 of the power screw 438 and the inner tubular wall 416 of the lower piston body 414. The opposed inner liquid lip seals 464 of the inner piston seal 460 provide a liquid-tight seal between the shaft 446 of the power screw 438 and the inner tubular wall 416 of the lower piston body 414.

A collar 466 surrounds the rim at the upper end of the inner tubular wall 416. The interior of the collar 466 is internally splined with one or more longitudinally-extending ribs that engage with one or more complementary grooves on the outside of the piston body sleeve. This prevents the piston assembly 452 turning within the housing 444 and so constrains the piston assembly 452 to move only longitudinally with respect to the housing 444.

In this embodiment, the vacuum spring pump 410 defines two separate annular spaces between the shaft 446 of the power screw 438 and the outer tubular wall 412 of the lower pump body 414, as follows:
firstly, a sealed variable-volume liquid chamber 472 is defined between the shaft 446 of the power screw 438, the inner tubular wall 416 of the lower pump body 414, the base wall 428 of the lower pump body 414 and the liquid lip seals 464 of the inner piston seal 460; and
secondly, a negative-pressure gas or vacuum chamber 474 is defined between the outer tubular wall 412 of the lower pump body 414, the shelf 418 joining the inner tubular wall 416 and the outer tubular wall 412, the inner tubular wall 416, the piston body sleeve 456 and the gas lip seals 462 of the inner piston seal 460.

Advantageously, this removes one sealing interface, which reduces the cost and complexity of manufacture and eliminates a potential source of failure.

The charging and dispensing actions of this embodiment are as for the embodiments shown in FIGS. 9 to 16.

In FIGS. 19 to 20, a further embodiment of a vacuum spring pump of the present invention is shown. The vacuum spring pump 510 has some components in common with the vacuum spring pumps 210, 310, 410 described above with reference to FIGS. 9 to 18.

The dispense head, helical spring, actuation valve, and optional actuation sleeve and actuation button are common to the embodiment shown in FIGS. 9 to 18 and have been omitted from FIGS. 19 to 20 for clarity.

A pump housing 512 of the vacuum spring pump 510 comprises an upper pump body 514, a lower pump body 516 and a generally cylindrical pump barrel 518 depending from the lower pump body 516. The upper pump body 514, the lower pump body 516 and the pump barrel 518 are each rotationally symmetrical about a central longitudinal axis 520 that lies in a generally vertical orientation when the pump 510 is oriented for use.

The lower pump body 516 has an inner tubular wall 522 concentrically arranged within an outer tubular wall 524. The inner and outer tubular walls 522, 524 are joined by an annular base wall 526 that surrounds a central hole. The outer tubular wall 524 extends upwardly from the outer periphery of the base wall 526 whereas the inner tubular wall 522 extends upwardly from the periphery of the central hole. An annular trough 528 is defined between the outer tubular wall 524, the inner tubular wall 522 and the base wall 526. The inner tubular wall 522 surrounds a central cylindrical channel 530.

The pump barrel 518 is mounted directly below the central cylindrical channel 530 of the lower pump body 516. The pump barrel 518 is supported under the base wall 526 of the lower pump body 516 by a depending annular skirt 532 that receives an upper portion of the pump barrel 518. The skirt 532 lies radially outward of, and is axially displaced from, the inner tubular wall 522 of the lower pump body 516 on the other side of the base wall 526. Thus, the tubular side wall of the pump barrel 518 is also radially outward of, and is axially displaced from, the inner tubular wall 522 of the lower pump body 516.

The pump barrel 518 is closed at its lower or inner end by an end wall 534. The end wall 534 of the pump barrel 518 has a central opening 536 through which liquid may enter the pump barrel 518. The opening 536 comprises a one-way valve 538 and, on the exterior side of the end wall 534, a formation 540 for attaching a dip tube (not shown) that extends into liquid to be dispensed, held in the container below when in use.

As for the embodiments above, the upper pump body 514 is positioned upwardly or outwardly of the lower pump body 516 on the same central longitudinal axis 520 and is retained on the lower pump body 516 by resilient snap fittings 542.

A central power screw 544 comprises a hollow elongate tubular shaft 546 that is centred on the central longitudinal axis 520 and turns about that axis within the housing 512. In this embodiment, at its closed inner or lower end, the shaft 546 extends to, and bears against, the end wall 534 of the pump barrel 518.

The pump housing 512 surrounds and supports a single piston assembly 548. The piston assembly 548 comprises a piston body 550, an annular inner piston seal 552 that slides longitudinally within the pump barrel 518 around the shaft 546 of the power screw 544 and an annular outer piston seal 554 that slides longitudinally within the annular trough 528.

The piston body 550 is formed of rigid plastics whereas the piston seals 552, 554 are of resilient plastics or rubber. The piston body 550 surrounds the power screw 544 and is engaged with the power screw 544. For this purpose, the power screw 544 has a male thread and the piston body 550 has a complementary female thread.

To prevent rotation of the piston assembly 548 in the housing 512, anti-rotation features as described for the embodiment shown in FIGS. 9 to 18 may be employed.

As for the embodiments shown in FIGS. 9 to 18, the piston body 550 is shaped to define a tubular inner skirt 556 that supports and stiffens the inner piston seal 552 and onto which the piston seal 552 fits. In this embodiment, the inner skirt 556 is extended to reach the inner piston seal 552 in the pump barrel 518 positioned downwardly or inwardly with respect to the lower pump body 516.

As in the embodiment shown in FIGS. 9 to 18, the piston body 550 further comprises a downwardly-depending, open-bottomed, frusto-conical outer skirt 558 that is joined at its apex to the upper or outer end of the tubular inner skirt 556. The outer skirt 558 widens at its lower or inner end to an outer seal support 560 that is parallel to, and concentrically arranged around, the inner skirt 556. The outer piston seal 554 surrounds the outer seal support 560 and is engaged on the outer seal support 560 by resilient snap connectors, overmoulding or adhesive.

The inner piston seal 552 has lip seal formations that extend axially in the direction of relative movement between the inner piston seal 552, the shaft 546 of the power screw 544 and the interior of the pump barrel 518. The lip seal formations are paired, with a first formation of each pair sliding against the interior of the pump barrel 518 and a second formation of each pair sliding against the exterior of the shaft 546. The lip seal formations on the inner piston seal 552 are a pair of outer or upper wiper seals 562 and a pair of inner or lower liquid seals 564.

The outer piston seal 554 has a pair of annular lip seal formations that extend axially in the direction of relative movement between the outer piston seal 554, the exterior of the inner tubular wall 522 and the interior of the outer tubular wall 524. The lip seal formations on the outer piston seal serve as gas seals 566.

The vacuum spring pump 510 has two separate annular spaces as follows:
firstly, a sealed variable-volume liquid chamber 568 is defined between the shaft 546 of the power screw 544, the interior of the pump barrel 518, the end wall 534 of the pump barrel 518 and the liquid seals 564 on the inner piston seal 552; and
secondly, a negative-pressure gas or vacuum chamber 570 is defined between the exterior of the inner tubular wall 522 of the lower pump body 516, the interior of the outer tubular wall 524 of the lower pump body 516, the annular base wall 526 of the lower pump body 516, and the gas seals 566 of the outer piston seal 554.

The charging and dispensing actions of this embodiment are as for the embodiments shown in FIGS. 9 to 18.

Advantageously, in this embodiment, the diameter of the central channel 530 in the lower pump body 516 is determined by the diameter of the tubular inner skirt 556 of the piston body 550 surrounding the power screw 544, rather than by the diameter of the liquid chamber 568. This allows for a reduction in the outer diameter of the annular trough 528 of the lower pump body 516 which, in turn, allows for a reduction in the overall diameter of the gas spring pump 510.

In FIGS. 21 to 22, a further embodiment of a vacuum spring pump of the present invention is shown. The vacuum spring pump 610 has some components in common with the vacuum spring pump described above with reference to FIGS. 9 to 20.

Again, the dispense head, helical spring and actuation valve are common to the embodiments shown in FIGS. 9 to 20 and have been omitted from FIGS. 21 to 22 for clarity.

A pump housing 612 of the vacuum spring pump 610 comprises an upper pump body 614 and a lower pump body 616. The lower pump body 616 has a tubular inner wall 618 concentrically arranged within a tubular outer wall 620. The tubular inner and outer walls 618, 620 are joined at the bottom by an annular wall 622 that surrounds a central recess 624. The outer tubular wall 620 extends upwardly from the outer periphery of the annular wall 622 and the inner tubular wall 618 extends upwardly from the periphery of the central recess 624. An annular trough 626 is defined between the outer tubular wall 620, the tubular inner wall 618 and the annular wall 622. The tubular inner wall 618 surrounds an open-topped cylindrical central well 628 that is closed at its bottom by a base wall 630 inset within the recess 624. Thus, the base wall 630 is axially displaced upwardly or outwardly with respect to the annular wall 622.

The base wall 630 has a central opening 632 through which liquid may pass into the central well 628. The opening 632 comprises a one-way valve 634 and, on the exterior side of the base wall 630, a formation 636 for attaching a dip tube (not shown).

The vacuum spring pump 610 shown in FIGS. 21 and 22 can attach to a container via any suitable attachment formations added to outside of the lower pump body 616. Such formations may, for example, be disposed on the outer edge of the lower pump body 616; in this configuration, most of the pump 610 protrudes from the container to maximise volume for liquid to be dispensed.

The upper pump body 614 is positioned upwardly or outwardly with respect to the lower pump body 616 on the same central longitudinal axis 638. The upper pump body 614 is retained on the lower pump body 616 by resilient snap fittings, friction, adhesive and/or by welding together the components after assembly.

In this embodiment, the upper pump body 614 comprises a tubular skirt 640 that fits closely within the upper or outer end of the outer tubular wall 620 of the lower pump body 616. An annular stop flange 642 encircling the skirt 640 limits the depth of insertion of the skirt 640 into the outer tubular wall 620.

The upper pump body 614 has a large central hole centred on the central longitudinal axis 638 to accommodate a central power screw 644. The power screw 644 is much enlarged in the radial direction compared to the power screws of the preceding embodiments and has additional functionality.

The power screw 644 comprises a hollow elongate tubular inner shaft 646 that is centred on the central longitudinal axis 638 and that turns about that axis within the housing 612. At its closed inner or lower end, the inner shaft 646 extends to, and bears against, the base wall 630 of the housing 612 at the bottom of the central well 628.

An integral head 648 surrounding the outer or upper open end of the inner shaft 646 is positioned outside the housing 612 to lie within the dispense head. The head 648 is a generally circular disc extending radially outwardly from the inner shaft 646. A radially outer edge of the head 648 is externally toothed in plan view to engage with one or more inwardly-projecting lugs of the dispense head. Such engagement occurs when the dispense head is in an outward or upper rest position, under the bias of the helical spring.

In this embodiment, the power screw 644 further comprises a hollow elongate tubular outer shaft 650 that surrounds the inner shaft 646 in concentric relation. The inner and outer shafts 646, 650 are integrally joined by the head 648 of the power screw 644. The outer shaft 650 is spaced from the inner shaft 646 to leave an annular space between the inner and outer shafts 646, 650. The outer shaft 650 depends from a radially-outer region of the head 648, just inside the toothed perimeter of the head.

A male helical thread surrounds the inner shaft 646 and extends from the head 648 approximately half-way along the inner shaft 646.

The outer shaft 650 is encircled by a radially-extending flange 652 that engages the central hole of the upper pump body 614 to retain the power screw 644 with respect to the housing 612 as a snap-fit under the upper pump body 614 around the edge of the hole.

At its lower, inward end, the tubular wall of the annular outer shaft 650 has an integral female-threaded circumferential ridge 654 that faces radially inwardly. This female thread of the outer shaft 650 has a different pitch to the male thread of the inner shaft 646.

The pump housing 612 surrounds and supports a piston assembly 655 comprising inner 656 and outer 658 piston assemblies. The inner piston assembly 656 comprises an inner piston body 660 supporting an annular inner piston seal 662 that slides longitudinally within the central well 628. The outer piston assembly 658 comprises an outer piston body 664 including an annular outer piston seal 668 that slides longitudinally within the annular trough 626.

The outer piston body 664 has a male helical thread on its radially-outer side. That thread engages the female-threaded circumferential ridge 654 at the bottom of the outer shaft 650 of the power screw 644.

The inner piston body 660 is formed of rigid plastics whereas the inner piston seal 662 is of resilient plastics or rubber. The inner piston body 660 surrounds the power screw 644 and has a female thread that is engaged with the complementary male thread of the power screw 644.

The inner piston body 660 comprises concentric inner 670 and outer 672 skirts. As best seen in FIG. 21, the outer skirt 672 of the inner piston body 660 lies generally parallel to the inner skirt 670 of the inner piston body 660 to define a downwardly-facing annular recess 674. That recess receives and closely embraces the tubular inner wall 618 of the lower pump body 616 when the pump 610 is in a resting, zero-charge position (FIG. 21). The recess 674 also guides reciprocal motion of the inner piston body 660 with respect to the tubular inner wall 618 as the inner piston body 660 moves longitudinally along the power screw 644 in use (FIGS. 21 to 22).

The interior of the outer skirt 672 of the inner piston body 660 is internally splined with one or more longitudinally-extending ribs that engage with one or more complementary grooves on the outer side of the tubular inner wall 618. This prevents rotation of the inner piston body 660 with respect to the housing 612.

At its lower, inward end, the outer skirt 672 of the inner piston body 660 has further anti-rotation formations that face radially outwardly to cooperate with the outer piston body 664. Specifically, the outer piston body 664 has circumferentially-spaced, longitudinally-extending ribs on its radially-inner side that engage with the anti-rotation formations on the outer skirt 672 of the inner piston body 660. This prevents the inner and outer piston assemblies 656, 658 turning relative to each other and so constrains both of the piston assemblies 656, 658 to move only longitudinally with respect to the housing 612, noting that the inner piston assembly 656 is also connected to the housing 612 by anti-rotation provisions.

The inner piston seal 662 has lip seal formations that extend axially in the direction of relative movement between the inner piston seal 662, the inner shaft 646 of the power screw 644 and the interior of the tubular inner wall 618 of the lower pump body 616. The lip seal formations are paired, with a first formation of each pair sliding against the interior of the tubular inner wall 618 and a second formation of each pair sliding against the exterior of the inner shaft 646. The lip seal formations of the piston seal are a pair of outer or upper wiper seals 675 and a pair of inner or lower liquid seals 676.

The outer piston seal 668 has lip seal formations that extend axially in the direction of relative movement between the outer piston seal 668, the exterior of the tubular inner wall 618 and the interior of the tubular outer wall 620. The lip seal formations are paired, with a first formation of the pair sliding against the exterior of the inner tubular wall 618 and a second formation of the pair sliding against the interior of the outer tubular wall 620. The lip seal formations on the outer piston seal serve as gas seals 678.

Thus, the vacuum spring pump 610 has two separate annular spaces as follows:
firstly, a sealed variable-volume liquid chamber 680 is defined between the inner shaft of the power screw 646, the interior of the inner tubular wall 618 of the lower pump body 616, the base wall 630 at the bottom of the central well 628, and the liquid seals 676 on the inner piston seal 662; and
secondly, a negative-pressure gas or vacuum chamber 682 is defined between the exterior of the tubular inner wall 618 of the lower pump body 616, the interior of the tubular outer wall 620 of the lower pump body 616, the annular wall 622 of the lower pump body 616 and the gas seals 678 of the outer piston seal 668.

As above, and as best seen in FIG. 21, a pinhole aperture 684 that penetrates the tubular wall of the inner shaft 646 is positioned to be opened and closed by the radially-inward side of the inner piston seal 662 as that seal slides along the inner shaft 646. The aperture 684 communicates between the liquid chamber 680 and the hollow interior of the shaft 646.

The method of charging the gas spring pump shares some features with that of the embodiments of the gas spring pump of the invention above. Consequently, only the differences are described in detail.

As before, during charging, the power screw 644 is turned by a user gripping and turning the dispense head, either directly or via an optional actuation sleeve, relative to the housing 612 and the container. However, in this embodiment, turning the power screw 646 relative to the housing has two different effects.

Firstly, rotation of the power screw 644 drives the inner piston assembly 656 upwards along the inner shaft 646 of the power screw 644 by virtue of the complementary mating helical threads on the inner shaft 646 and the inner piston assembly 656. Upward or outward movement of the inner piston assembly 656 along the longitudinal axis of the inner shaft 646 expands the liquid chamber 680 thereby drawing down a partial vacuum within. That negative pressure draws liquid to be dispensed from the container into the liquid chamber 680 via the dip tube (not shown) and the one-way valve 634 in the opening 632 in the base wall 630 of the housing 612. Upward or outward movement of the inner piston assembly 656 also opens the pinhole aperture 684 in the tubular wall of the shaft 646.

Secondly, rotation of the power screw 644 drives the outer piston assembly 658 upwards or outwards parallel to the central longitudinal axis of the power screw 644 by virtue of the complementary mating helical threads on outer piston assembly 658 and the outer shaft 646 of the power screw 644.

Expansion of the sealed vacuum chamber 682 due to the upward movement of the outer piston assembly 658 generates a partial vacuum within that chamber. The below-atmospheric or negative pressure of the gas within the vacuum chamber 682 biases the outer piston assembly 658 inwardly or downwardly, thereby acting as a negative-pressure air spring.

The power screw 644 continues to turn until either the inner piston assembly 656 or the outer piston assembly 658 reach the end of their respective threads or until the inner piston assembly 656 or the outer piston assembly 658 encounter the head 648 of the power screw 644, which blocks further movement. Gas in the vacuum chamber 682 is now at minimum pressure, which tends to drive the outer piston assembly 658 inwards or downwards when the user releases the dispense head.

As the outer piston assembly 658 is constrained to move longitudinally within the housing 612 and not to turn within the housing 612, such movement of the outer piston assembly 658 will cause the power screw 644 and hence the dispense head to counter-rotate. This counter-rotation is typically prevented by the back-pressure of the fluid in the system. Optionally, counter-rotational movement of the power screw 644 may be prevented by engagement of a rotation lock (not shown) acting on the power screw 644 or the dispense head.

The vacuum spring pump 610 is now in a charged state (FIG. 22). Discharge of the vacuum spring pump 610 involves disengaging the power screw 644 from the dispense head. Disengagement of the power screw 644 and the dispense head may be achieved by the user pressing on the dispense head directly or via an actuation button as described in earlier embodiments. This allows counter-rotation of the power screw 644 driven by inward or downward movement of the outer piston assembly 658 due to the low pressure in the vacuum chamber 682. In turn, the counter-rotation of the power screw 644 drives the inner piston assembly 656 inwards or downwards. This pressurises the liquid in the liquid chamber 680 and forces it up the hollow interior of the inner shaft 646 to be dispensed through the nozzle of the dispense head.

The relative pitch of the threads between the outer piston body 664 and the outer shaft 650 of the power screw 644 and between the inner piston body 660 and the inner shaft 646 of the power screw 644 can be varied as noted above. This option provides for differential longitudinal travel between the inner piston seal 662 and outer piston seal 668 when the power screw 644 turns. Advantageously, this separates the movement of the inner and outer seals, which provides an additional way of configuring the mechanism to balance conflicting requirements of torque, angular movement, profile and overall dimensions.

1. A pump mechanism for a spray dispenser, comprising:
a housing;
a piston assembly movable with respect to the housing between a charged position and an initial position, the piston assembly comprising a liquid seal and a gas seal, each of said liquid seal and said gas seal being in slidable sealed relation with the housing;
a sealed gas chamber of which the gas seal is a movable boundary, such that a volume of the gas chamber is determined by a position of the gas seal relative to the housing; and
a liquid chamber of which the liquid seal is a movable boundary, such that a volume of the liquid chamber is determined by a position of the liquid seal relative to the housing, the liquid chamber comprising an inlet to admit liquid into the liquid chamber, and an outlet to expel admitted liquid from the liquid chamber for dispensing;
wherein, when the piston assembly moves from the initial position to the charged position,
the volume of the liquid chamber is increased by movement of the liquid seal to draw liquid into the liquid chamber via the inlet;
the volume of the gas chamber is changed by movement of the gas seal to change an internal pressure of gas in the gas chamber from a pressure of said gas when the piston assembly was in the initial position; and
the changed internal pressure in the gas chamber biases the piston assembly to return subsequently from the charged position toward the initial position such that return movement of the piston assembly moves the liquid seal relative to the housing to pressurize the liquid drawn into the liquid chamber for dispensing via the outlet.

2. The pump mechanism of claim 1, wherein:
when the piston assembly moves from the initial position to the charged position, the volume of the sealed gas chamber is decreased and the internal pressure of the gas is increased; or
when the piston assembly moves from the charged position to the initial position, the volume of the sealed gas chamber is increased and the internal pressure of the gas is decreased.

3. The pump mechanism of claim 1, wherein:
when the piston assembly moves from the initial position to the charged position, the volume of the sealed gas chamber is increased and the internal pressure of the gas is decreased; or
when the piston assembly moves from the charged position to the initial position, the volume of the sealed gas chamber is decreased and the internal pressure of the gas is increased.

4. The pump mechanism of claim 1, wherein the housing comprises a tubular body closed by a base wall.

5. The pump mechanism of claim 4, wherein the base wall comprises the inlet to the liquid chamber.

6. The pump mechanism of claim 1, wherein a non-return valve is provided in a duct leading to the inlet.

7. The pump mechanism of claim 1, wherein the pump mechanism further comprises a power screw engaged with the piston assembly whereby rotation of the power screw moves the piston assembly axially along the power screw between the initial position and the charged position.

8. The pump mechanism of claim 7, wherein the pump mechanism further comprises a dispense head that is movable between an extended rest position in which the power screw is engaged with the dispense head to prevent rotation of the power screw relative to the dispense head, and a depressed actuating position in which the power screw is disengaged from the dispense head to permit rotation of the power screw relative to the dispense head.

9. The pump mechanism of claim 8, wherein the power screw comprises a radially-extending head piece having one or more engagement formations for engagement with one or more complementary engagement formations of the dispense head when the dispense head is in the rest position.

10. The pump mechanism of claim 9, wherein the head piece is a disc having a radially outer edge that comprises external radially-extending teeth engageable with one or more inwardly-facing lugs of the dispense head when the dispense head is in the rest position.

11. The pump mechanism of claim 7, wherein the power screw comprises an elongate shaft.

12. The pump mechanism of claim 11, wherein the shaft extends through the piston assembly.

13. The pump mechanism of claim 11, wherein the shaft is hollow with a closed end and an open end.

14. The pump mechanism of claim 13, wherein at or near its closed end, the shaft comprises the outlet of the liquid chamber.

15. The pump mechanism of claim 14, wherein the outlet is an aperture in the shaft for fluid communication between the liquid chamber and the hollow interior of the shaft.

16. The pump mechanism of claim 15, wherein the aperture is closed by the liquid seal when the piston assembly moves toward the initial position.

17. The pump mechanism of claim 15, wherein the pump mechanism further comprises an actuation valve that is operable to seal the open end of the shaft in response to release of a dispense head from a depressed actuating position.

18. The pump mechanism of claim 17, wherein the actuation valve is positioned within the open end of the shaft to seal the hollow shaft of the power screw, the actuation valve comprising a valve seat and an actuation stem that extends through the valve seat and is movable relative to the valve seat by movement of the dispense head.

19. The pump mechanism of claim 7, wherein the power screw comprises a retainer formation that engages with the housing or with a retainer part supported by the housing to retain the power screw in a longitudinally-fixed position relative to the housing.

20. The pump mechanism of claim 1, wherein the liquid chamber and the gas chamber are contained within the housing.

21. The pump mechanism of claim 20, wherein the liquid chamber is longitudinally displaced from the gas chamber.

22. The pump mechanism of claim 20, wherein the gas chamber extends radially outboard of the liquid chamber.

23. The pump mechanism of claim 22, wherein the gas chamber is concentrically arranged around the liquid chamber.

24. The pump mechanism of claim 22, wherein the liquid chamber extends radially outboard of a radially inner wall of the gas chamber.

25. The pump mechanism of claim 1, wherein when the piston assembly is in the initial position, the gas pressure within the gas chamber is above or below ambient pressure.

26. The pump mechanism of claim 1, wherein the liquid seal and the gas seal are formed as a single seal formation.

27. The pump mechanism of claim 1, wherein rotation of the piston assembly is prevented by anti-rotation features between the housing and the piston assembly.

28. The pump mechanism of claim 27, wherein anti-rotation features are slots or grooves or splines.

29. The pump mechanism of claim 1, wherein the pump mechanism is configured to provide a duration of spray in a range of 1 to 50 seconds.

30. The pump mechanism of claim 1, wherein the gas sealed in the gas chamber is air.

31. The pump mechanism of claim 1, wherein the housing further comprises an annular collar for connecting the pump mechanism to a container.

32. A spray dispenser comprising:
a container; and
a pump mechanism of claim 1 fitted to the container.

33. The spray dispenser of claim 32, wherein the pump mechanism is fitted to the container to lie concentrically within the container.

34. The spray dispenser of claim 33, wherein only a dispense head of the pump mechanism protrudes from an interior volume of the container.

35. The pump mechanism of claim 1, wherein the pump mechanism is configured to provide a duration of spray in a range of 1 to 20 seconds.
